(19) United States
(12) Patent Application Publication
(10) Pub. No.: US 2026/0031247 A1
(43) Pub. Date: Jan. 29, 2026

(54) COMPUTER APPARATUS FOR MONITORING AND VERIFYING NUCLEAR AND FOSSIL POWER PLANT HEAT LOSSES BASED ON THE REVISED NCV METHOD

(71) Applicant: Fred Donald Lang, Salt Spring Island (CA)

(72) Inventor: Fred Donald Lang, Salt Spring Island (CA)

(21) Appl. No.: 19/238,414

(22) Filed: Jun. 14, 2025

Related U.S. Application Data
(63) Continuation-in-part of application No. 18/949,993, filed on Nov. 16, 2024, now Pat. No. 12,417,856.
Application No. 18/949,993 is a continuation of application No. 18/444,473, filed on Feb. 16, 2024, now Pat. No. 12,198,822.

(51) Int. Cl. G21C 17/032; G21C 7/32; G21C 17/022

(52) U.S. Cl. CPC G21C 17/032; G21C 7/32; G21C 17/022; Y02E 30/30

(57) ABSTRACT

This invention discloses a computer apparatus whose instructions describe a process which greatly improves the analysis of system entropy flows, irreversible losses and Carnot Reversibilities associated with heat exchangers used in all thermal engines. Irreversible losses include those from shell and tube heat exchangers, as a component, and those from the shell-side of heat exchangers such as condensers. The understanding of any thermal engine lies with either understanding its inputs and useful power output, and/or understanding system losses. This disclosure focuses on entropy flows and system losses. It results in revision to the classic Carnot Engine resulting in an Exergetic Engine. Although Exergetic Engine's roots are embedded in Carnot's device, its invention is uniquely created by recognizing true thermodynamic irreversibility associated with any heat exchanger is determined by the summation of its internal exergy flows. This leads to a correction of Sadi Carnot's T_{Hot}. For the nuclear engine, his T_{Cold} is also redefined as a Fixed T_{Ref} dependent on neutronic constants and the core's coolant properties. Correcting his 200 year-old teachings produce a highly accurate irreversible loss, and thus a highly accurate Carnot Reversibility which improves the thermodynamic understanding of all thermal engines. With such improved understanding, the system operator has actionable intelligence which can protect the public, and corrects degradations within the power plant which improve operations.

### CROSS-REFERENCE TO RELATED APPLICATIONS

This application is being filed as a Continuation-In-Part of U.S. Utility application Ser. No. 18/949,993 ('993) filed Nov. 16, 2024; '993 was filed as a Continuation of U.S. Utility application Ser. No. 18/444,473 ('473) filed Feb. 16, 2024; '473 was issued as U.S. Pat. No. 12,198,822 ('822) on Jan. 14, 2025, corrected on Mar. 25, 2025; '993, '473 and '822 are hereby incorporated by reference in their entireties and for all purposes.

### COPYRIGHT NOTICE

A portion of the disclosure of this patent document contains material which is subject to Copyright protection. The Copyright owner has no objection to the facsimile reproduction by anyone of the patent document or the patent disclosure, as it appears in the Patent and Trademark Office patent file or records, but otherwise reserves all Copyright rights whatsoever.

### BACKGROUND OF THE INVENTION

### Field of the Invention

This invention discloses a computer apparatus which greatly improves the analysis of heat losses from nuclear and fossil-fired power plants. Said heat losses include those from a shell and tube heat exchanger with energy flow loss to the local environment, or a heat exchanger whose thermodynamic boundary only includes one-side of the heat exchanger (such the tube-side of a fossil-fired Steam Generator providing steam to a Turbine Cycle, or the shell-side of a condenser which exhausts its energy flow to the local environment). The understanding of all thermal engines lie with either understanding “inputs” and the useful power output, or understanding heat losses. This disclosure focuses on heat losses, given use of a revised Carnot Engine, and Second Law techniques involving the flow of entropy. Further, it provides verification of that understanding thereby providing the system operator with actionable information. A significant feature of said process is the use of an “Exergetic Engine” which, with high accuracy, allows unique evaluation of heat exchanger thermodynamic losses. In the process of verifying irreversible losses, this disclosure teaches the analysis of a thermal engine's entropy flows. These are based on First Law less Second Law system descriptions. The verification process leads to comparing Entropy Flows and their ratios to those associated with known neutronic and thermodynamic standards (e.g., electrical generation, the Inertial Conversion Factor and/or system data having known accuracy). For the nuclear engine, verification means to compare a computed Inertial Conversion Factor (Ξ) versus its equivalence based on thermodynamic properties. Ξ is based on the ratio of neutrino versus total MeV release (thus constant for a given burnup and whose min/max values are known). For the fossil engine, verification means to use one or more of the four Input/Loss Method's verification techniques provided their major components (e.g., the condenser and system heat exchangers) employ the measures taught here, that is correcting T_{Hot} for Σ_{Shell} mgₖ and ΔT_{SCY} effects. For discussion of the four Input/Loss verification techniques, see the reference: FD Lang, “Monitoring and Improving Coal-Fired Power Plants Using the Input/Loss Method—Part V”, Proceedings of the 2007 ASME Power Conference, POWER2007-22009.

One of the most important processes of any thermal engine is its heat rejection to the local environment. Two hundred years ago Sadi Carnot taught that the “greatest caloric production” associated with any thermal engine is a f(T_{Hot}−T_{Cold}) operating between thermal reservoirs. His classic Carnot Engine consisted of two isothermal processes connected to two adiabatic processes, operating reversibly. This was the basis for assuming that the irreversible loss associated with any thermal engine's heat rejection (Q_{Loss}) to its environment is the Carnot Engine's theoretical caloric production: [1−T_{Cold}/T_{Hot}]Q_{Loss}; yet this is not correct. Of course, both the Carnot Engine and the Exergetic Engine are theoretical, they are computational devices which produce an irreversible loss, and for the Exergetic Engine its Carnot Reversibility.

Although Exergetic Engine's roots are embedded in Carnot's device, it is uniquely modified by recognizing that the true thermodynamic irreversibility associated with all shell and tube heat exchangers (HTX) is given by the relationship: I_{HTX} ≡[Σ_{Shell} (mg)ₖ+Σ_{Tube} (mg)ₖₖ]. Sadi Carnot's interpretation of the effects of a Q_{HTX}, a heat transfer [−Σ_{Shell} (mh)ₖ], is governed by his relationship [1−T_{Ref}/T_{Hot}]Q_{HTX}; the question then proposed is: I_{HTX} [symbol] [1−T_{Ref}/T_{Hot}]Q_{HTX}. In a 1824 world the questioned relationship would be equated; in the world of this disclosure, it is not. It is now seen as a 200 year-old error. There are two related reasons for non-equivalence. First, “exergy” must satisfy the thermodynamic equation of state: Tds=dh−vdp; thus: T=[∂h/∂s]_{P} which will equal Carnot's T_{Hot} only by happenstance. Second, the Σ_{Shell} (mh)ₖ term represents shell outlet less inlet streams; outlet conditions were ignored by Carnot. T_{Hot} is corrected so that exergy flows and Carnot's processing of Q_{HTX} are always equivalent. Correcting Carnot's teachings results in computing a highly accurate irreversible loss and Carnot Reversibility, thereby improving the thermodynamic understanding of thermal engines. With an improved understanding the system operator has information to protect the public and/or to instigate actions to improve thermal efficiencies.

### Description of Related Art

Heat Exchangers (e.g., condensers) are integral to all Regenerative Rankine Cycles; they are employed by both nuclear and fossil-fired thermal engines. The genesis for this work lie with the Neutronics/Calorimetrics/Verification (NCV) Method which taught new monitoring techniques for both thermal performance and safe operation of nuclear power plants . . . the complete system from neutronics to condenser heat rejection. Its descriptive engineering was based on the Second Law of thermodynamics' exergy analysis. Although the safe operation of nuclear power is not directly applicable, foundations of the NCV Method lead to the development of Carnot Reversibilities (e.g., condenser analytics), Entropy Flows, and thermal performance technologies which are disclosed herein. Fossil-fire power plant condensers are also directly impacted. The NCV Method was granted U.S. Pat. No. 12,198,822 ('822) on Jan. 14, 2025, corrected on Mar. 25, 2025, hereinafter '822.

Assumed throughout is that for a shell and tube heat exchanger, its shell-side is the hotter fluid (i.e., associated with T_{Hot}) being cooled by heating the tube-side. Although conventional, this is not universal; as used in a PWR, its Steam Generator is designed to cool the tube-side (reactor coolant) by heating the shell thereby generating a steam supply. Throughout this disclosure, “shell-side” is defined as the fluid being cooled, “tube-side” is defined as the fluid being heated. If, in a given design the tube-side is the hotter fluid, then nomenclature is reverse.

Common art associated with the thermal performance monitoring of condensers includes the following concepts: the summation of a heat exchanger's exergy flows (outlets less inlets) herein defines a “true thermodynamic irreversible loss,”−[Σ_{Shell} (mg)ₖ+Σ_{Tube} (mg)ₖₖ]; the use of heat exchanger effectiveness (based on exergy analysis) to eliminate tube-side conditions; use of the fossil fuel's calorimetric temperature (T_{CAL}); and proper use of the reference temperature used in exergy analysis. The concept using heat exchanger effectiveness was first used by this inventor in the early 2000s when monitoring fossil-fired power plants. He lectured on this concept to power plant staffs in the United States, Ireland and Greece, but does not recall publishing; it is considered common art. The thermodynamic base for the Carnot Engine was developed by Nicolas Sadi Carnot in 1824; it has also been termed the “Carnot Thermal Engine”. Carnot's principles laid the foundations for the Second Law of thermodynamics in that no thermal engine can be more efficient than a reversible one operating between T_{Hot} and T_{Cold} reservoirs. It has been used for two hundred years without modification. For example, when applied to a thermal engine's condenser, there is no known art which has not taken T_{Hot} as the saturation temperature of the fluid being condensed. This is in error as T_{Hot} requires correction. T_{Cold} has typically been taken as the condenser's tube-side inlet temperature (the coldest reservoir seen by the thermal engine). When applied to a nuclear power plant, this is in error.

For any heat exchanger its irreversible loss is given by I_{HTX}. If the shell-side fluid is heating the tube-side (e.g., shell-side steam is being condensed), then the sum of shell exergy flows must be negative, and numerically greater than the tube-side's increase in exergy flow. Thus, a net negative exergy flow represents an I_{Cond}>0.0; if this is not the case the heat exchanger violates the Second Law (heat would flow from T_{Cold} to T_{Hot}). Second Law effectiveness is logically defined as: ε_{Cond}=−mΔg_{Tube}/Σₛₕₑₗₗ (mg)ₖ. Thus, ε_{Cond}≤1.0 applies universally.

Use of the Carnot Engine when applied to any energy loss to the environmental is clearly common art, it has been in use since the industrial revolution. Indeed, thermodynamicists for years have pointed out that Second Law exergy analysis of power plants indicates that condensers in fossil-fired units have irreversible losses <5% of the total; this compared to condensers rejecting 60% to 70% of system supplied energy flows. This disclosure teaches that small irreversible losses in certain components can have a large impact on entropy flows, and thus affect the thermal understanding of the thermal engine; this is especially true for a nuclear engine.

Discussion of the classic Carnot Engine is required since this disclosure presents serious variations to the historic Engine, that are required to greatly improve the thermodynamic understanding of heat exchangers in general, and condensers in particular. The classic Carnot Engine is commonly used to develop a “loss power”. This term is associated with the Engine's production of the highest flow of availability (an exergy flow) possible, given a theoretical, cyclic operation on an energy flow when in transference to a thermal reservoir. This reservoir is assumed of practically infinite size and physically attached to the system. It is maintained at constant temperature which, for a condenser, was commonly taken as the tube-side inlet (the system's physical attachment to the coldest reservoir available in the local environment and attached to the exchanger).

There are two related technologies, both considered common art, which are relevant to this disclosure. These include the thermodynamics of fossil-fired Steam Generators and related Fossil Fuel Consumption Indices (FFCI) developed as part of the Input/Loss Method. All calorimetric values (heating values) of fossil fuels, of course, are dependent on a “calorimetric temperature”, T_{CAL}. When computing the Heat of Combustion for a gaseous fuel,

$$Δ {H}_{f}^{0}$$

are well defined standards at 25° C. and 1.0 Bar. For any other T_{Ref},

$$Δ {H}_{f}^{T}$$

can be computed (although

$$Δ {H}_{f - CO 2}^{T} \& Δ {H}_{f - SO 2}^{T}$$

vary little with temperature, not so with

$$Δ {H}_{f - H 2 O}^{T} ) .$$

When using an adiabatic or isoperibol bomb calorimeter to evaluate solid or liquid fuels its reference is, again, T_{CAL}. It is this temperature at which the bomb's water jacket is kept in an equilibrium state; a constant temperature chosen by the laboratory technician. Although one can easily compute, with high accuracy, the ideal products at T_{CAL}:

$$Δ {H}_{f - CO 2}^{T} , Δ {H}_{f - SO 2}^{T} , Δ {H}_{f - H 2 O}^{T} ,$$

etc.; it is not possible to compute a solid or liquid fuel reactant

$$Δ {H}_{f - RX}^{T}$$

(i.e., the chemistry of coals and fuel oils are too complex,

$$Δ {H}_{f - RX}^{T}$$

can only be evaluated by test). Thus, a basis for a “Products less Reactants” approach is created to compute a high accuracy boiler efficiency, all at constant calorimetric temperature (thus,

$$Δ {H}_{f - RX}^{T}$$

is back-calculated given a measured Heat of Combustion and computed ideal products). This approach and the Input/Loss Method were granted a number of United States and foreign patents, significant ones include: for boiler efficiency, U.S. Pat. No. 6,584,429 issued on Jun. 24, 2003, corrected on Sep. 9, 2003 (hereinafter '429); and for the Input/Loss Method, U.S. Pat. No. 7,809,526 issued on Oct. 5, 2010 (hereinafter '526). Miscellaneous US Patents teaching a variety of Input/Loss technologies include: U.S. Pat. Nos. 6,522,994, 6,560,563, 6,651,035, 6,691,054, 6,714,877, 6,745,152, 6,810,358, 6,868,368, 6,873,933, 7,039,555, 7,040,095, 7,328,132, 7,809,526 and 8,091,361. No patent issued to this inventor as related to the Input/Loss Method, or provisional or utility application related to the NCV Method, prior to '822, employs entropy flows, Carnot Reversibilities or an Exergetic Engine in its methodologies. In summary for the fossil engine, if the calorimetric temperature is not properly employed for the analysis of the fossil engine, the First Law is guaranteed not to conserve. Without conservation of energy flows, the use of Second Law exergy analysis on any thermal engine, with or without use of the Exergetic Engine, is a fool's errand.

Regarding the use of T_{CAL}, note that the latent heat of water at an As-Fired temperature is rarely the bomb calorimetric's value. The system's water energy flows will not be conserved given the combustion's water energy, wet combustion air and air leakage psychometrics (ASHRE uses 0.0° F. as gas property reference), water ingress, etc. all have differing thermodynamic dead states versus the fuel's T_{CAL}; for reference see: FD Lang, “Errors in Boiler Efficiency Standards”, Proceedings of the 2009, ASME Power Conference, POWER2009-81221. In summary, for the fossil-fired power plant T_{CAL} is set by the gaseous fuel analyst, or, for solid or liquid fuels, by the laboratory technician.

Also, relevant prior art includes the Input/Loss Method's Second Law exergy analysis used as a base for monitoring fossil-fired power plants. Input/Loss' development of a fossil-fired G_{IN} is considered common art for the fossil engine:

$${G}_{IN} ≡ {P}_{GEN} + {I}_{k} \qquad ( BG - 1 )$$

$$= {m}_{AF} {g}_{Fuel} + {m}_{Air} {g}_{Air} + \sum {G}_{Misc} + \sum {P}_{Pump} + \sum {P}_{Fan} \qquad ( BG - 2 )$$

Computing fuel exergy, g_{Fuel}, is complex as it involves converting the fuel's Heat of Combustion to a potential (an exergy). This involves the As-Fired hydrocarbon less the effect of all elementary constituents. Effect of elementary constituents means evaluating ideal combustion products less reactants, all based on Δhⱼ less T_{Ref}Δsⱼ molar terms. Miscellaneous exergy flow, ΣG_{Misc}, includes soot blowing, sorbent injection and Steam Generator tube leakage all flowing into the combustion space. The source of First Law energy flow into a fossil engine is given as the heating value (higher or lower) plus a Firing Correction term: HHVP+HBC. The Firing Correction corrects only the reactants to the same thermodynamic base established by the fuel's calorimetric temperature (T_{CAL}) including energy flows for combustion air, soot blowing, etc. Thus, an As-Fired hydrocarbon with its combustion air, leakages, etc., all enter the combustion space under the (corrected) same base. Combustion losses cannot affect the denominator in a boiler efficiency statement. Eq.(BG-1) lead to Fossil Fuel Consumption Indices (FFCI). For references for hydrocarbon's G_{IN} and early development of FFCI see: F D Lang and K F Horn, “Practical Experience with Second Law Power Plant Monitoring”, Proceedings of the Florence World Energy Research Symposium (Flowers '92), Firenze, Italy, Jun. 7-12, 1992, Ed. Sergio S. Stecco & Michael J. Moran, later published in the U S, also in Chinese, Italian, etc.; further development involving dynamic metrics lead to U.S. Pat. No. 6,799,146 issued on Sep. 28, 2004, corrected on Apr. 26, 2005. Recall that '822 teaches Fission Consumption Indices (FCI) via Col.35, Line 32 to Col.36, Line 39, patterned after FFCIs. FFCIs and FCIs are herein defined as “Consumption Indices”.

In summary, the use of a heat exchanger, or any thermal device losing heat to its environment, requires a high accuracy computing vehicle. Such accuracy includes numerical verification. There is no known art which redefines the meaning of Carnot's T_{Hot} and T_{Cold} temperatures. There is no known art which develops a method of using condenser reversibilities to identify degraded components within a thermal engine; and to make corrections based on that identification.

### BRIEF SUMMARY OF THE INVENTION

This invention discloses a theoretical “Exergetic Engine” which allows computation of irreversible and reversible quantities associated any physical heat exchanger device which cools a fluid by heating a fluid. The Exergetic Engine may also be applied to vessel convective and/or thermal radiative losses to the local environment. The physical device (say a condenser) is commonly designed in a shell and tube arrangement; typically the tube-side is being heated. The shell-side is cooled and usually has multiple fluid flows with different state properties (for a condenser, its shell inlet flows principally containing saturated steam, resulting in a condensed shell outlet flow). When applying First Law conservation of energy flows—given a nuclear or fossil engine—a condenser's heat rejection (Q_{REJ}) is simply dissipated in the local environment, a loss from the system (from a thermal engine's standpoint, thermodynamically, the “where” such heat rejection is dissipated is not relevant . . . we heat oceans and rivers to make electricity). Applying a classic Carnot Engine or the Exergetic Engine to any First Law study has no meaning. However, for any thermal engine, application of a classic Carnot Engine or an Exergetic Engine, the loss of Q_{REJ} from the system—given its resultant loss of availability—is, by definition, creates an irreversible loss. This loss is relative to a reference temperature, T_{Ref} (for the classic Carnot Engine T_{Ref} is assumed to be T_{Cold}, the coldest reservoir available). As defined herein, the phrase “Floated T_{Ref}” is a reference temperature chosen by the analyst (e.g., the condenser's tube-side inlet temperature). Also defined herein, the phrase “Fixed T_{Ref}” is a reference temperature which is held constant having no relationship with a thermal reservoir. For example, the nuclear reference T_{Ref}, based on the Inertial Conversion Factor (Ξ) of Eq.(9) and defined by Eq.(10) in '822, is a Fixed T_{Ref}.

With such background, this disclosure teaches that for any component exchanging heat (i.e., exchanging exergy flows), that T_{Hot} must be corrected with a ΔT_{Corr} derived from the true thermodynamic irreversibility, I_{HTX}. For the vast majority of condenser designs, their inlet and outlet tube-side consist of a single flow, whereas the shell-side comprises multiple inlets and a single outlet. For example, a condenser's principal inlet flow is the low-pressure turbine's exhaust (at saturation, T_{CDS}), but its shell also receives input streams comprising: return feedwater heater drains, turbine seals, valve by-pass leakages, heat exchanger blow-down flows, etc. If condensing saturated steam at T_{CDS}, correction is made by subtracting a Carnot-based loss from I_{HTX}, then solving for a corrected T_{Hot} (i.e., T_{CDX}), where: T_{CDX}=T_{CDS}+ΔT_{Corr}. In addition, when evaluating condensers, it becomes uniquely apparent that the system's flow of entropy reveals that accurately computing a condenser reversible gain (based on I_{Cond}) has a huge impact on understanding a power plant's thermal performance.

A technical paper, recently published, is available which explains both the NCV Method and presents numerical examples of system balances and use of the Exergetic Engine. Its reference is: FD Lang, “The Nuclear Second Law, Part I: Engineering,” its Rev.34D was published as independent research available at https://www.researchgate.net/publication/391672829.

### BRIEF DESCRIPTION OF THE DRAWINGS

FIG. 1A is a representation of two Exergetic Engines used to describe the irreversible effects of a heat exchanger's energy flow to its local environment, given the exchanger is treated as a shell and tube component; included is nomenclature of fluid inlets and outlets.

FIG. 1B is a representation of a single Exergetic Engine used to describe the irreversible effects of a heat exchanger's energy flow from its shell-side to its local environment.

FIG. 2 is a representation of thermodynamic laws, as taught FIG. 2 aids visualization of a First Law less a Second Law expressions.

### DETAILED DESCRIPTION OF THE INVENTION

To assure an appropriate teaching, descriptions of the computer apparatus are divided into the following sub-sections. The first two present Definitions of Terms and Typical Units of Measure, and the important Meaning of Terms. The remaining subsections, representing the bulk of the teachings, includes: The Exergetic Engine, System Entropy Flow, Verification of a Nuclear Engine's Entropy Flows, and Verification of a Fossil Engine's Entropy Flows.

### DEFINITIONS OF TERMS AND TYPICAL UNITS OF MEASURE

### System Terms

FCI_{Loss-k} or FFCI_{Loss-k}=Fission/Fossil Fuel Consumption Index for k^{th} irreversible loss; unitless
FCI_{Power} or FFCI_{Power}=Fission/Fossil Fuel Consumption Index for useful power output; unitless.
g≡(h−h_{Ref})−T_{Ref}(s−s_{Ref}), fluid specific exergy (also termed “available energy”); Btu/lbm.
G_{IN}=Total exergy flow input to a thermal system (e.g., nuclear & shaft power inputs); Btu/hr.
Δg_{ΔP-Corr} ≡[g_{STI}−g(P_{SCI}, h_{STI}, T_{Ref})]; exergy correction for a ΔP_{SCY} effect, see Eq.(14A); Btu/lbm

$$Δ {H}_{f - m}^{0}$$

=Heat of Formation of substance “m” at the standard state, 25° C. & 1.0 Bar; Btu/lb-mole.

$$Δ {H}_{f - m}^{T}$$

=Heat of Formation of substance “m” at temperature T; Btu/lb-mole.
h_{Ref}=Reference fluid specific enthalpy used for exergy's definition: f(P_{Ref}, x=0.0); Btu/lbm.
Iₖ=Irreversibility of the k^{th} process; Btu/hr
m or \dot{m}=Mass flow of fluid; lbm/hr.
mΔg or \dot{m}Δg=Exergy flow, also termed available power; Btu/hr.
mΔh or \dot{m}Δh=Energy flow, also termed thermal power; Btu/hr.
P_{Cond}=Condenser's shell-side indicated pressure; psiA.
P_{FWP-Aux}=Energy flow credit for a TC Auxiliary Turbine driving a FW pump; Btu/hr.
P_{GEN-REF}=Reference useful power output delivered to the turbine-generator; Btu/hr.
P_{GEN}=Useful power output delivered to the turbine-generator; Btu/hr.
P_{X-ii}=Motive power delivered to the ii^{th} individual X subsystem pump; Btu/hr.
P_{Ref}=Reference pressure for exergy analysis: P_{Ref}=f(T_{Ref}, x=0.0); psiA.
Q_{CTP}=Core Thermal Power, an energy flow, defined herein; Btu/hr.
Q_{Loss-X}=Vessel insulation losses from subsystem X; Btu/hr.
Q_{REC}=Recoverable exergy flow from fissile materials; Btu/hr.
Q_{REJ}=Condenser heat rejection from the TC, an energy flow; Btu/hr.
Q_{SG}=Net energy flow to a SG from combustion or nuclear power; Btu/hr.
Q_{TCQ}=Net energy flow delivered to the Turbine Cycle including pump power; Btu/hr.
s_{Ref}=Reference fluid specific entropy used for exergy analysis: f(P_{Ref}, h_{Ref}); Btu R⁻¹ lbm⁻¹.
T_{CDS}=Condenser shell-side temperature, typically saturation temperature; ° F.

$$\begin{matrix}{T}_{CDS - Corr} ≡ {T}_{C D S} = Corrected Condenser shell - side temperatue ; ° F . \\ ≡ {T}_{C D S} + Δ {T}_{C o r r}\end{matrix}$$

ΔT_{Corr}=Correction to the Exergetic Engine's T_{Hot} for compliance with Eq.(1); ° F.
T_{Ref}=Reference temperature for exergy analysis, can be defined by user for a fossil engine, or defined by Eq.(10) in '822 for the nuclear engine ° F. or ° R.
Tₛₐₜ=Saturation temperature of the condensing side of a heat exchanger; ° F.
V_{Fuel}=Volume of nuclear fuel consistent with the total macroscopic cross section; cm³.
x=Steam quality; mass fraction.
ε=Second Law effectiveness (some text books use Second Law efficiency); unitless.
Ξ=Inertial Conversion Factor defined by Eq.(9B) of '822; unitless.
υ_{XX}=Average exergy per fission release [this symbol is not ¹n₀/Fission]; MeV/Fission.
Σ=Summation of terms.
Σ_{F-j}=Macroscopic fission cross section for isotope j; cm⁻¹.
Φ_{TH}=Average neutron flux numerically satisfying the Calorimetrics Model; ¹n₀ cm⁻² sec⁻¹.

### Subscripts and Abbreviations

hh, ii, k, and kk denote indices for components; i denote system related indices.
AF=As-Fired, referring to fossil combustion.
CDP=Condensate system pump.
CDS=Condenser's saturation temperature, a function of its shell's operating pressure.
CTP=Core Thermal Power.
FCI=Fission Consumption Index.
FFCI=Fossil Fuel Consumption Index.
FWP=Feedwater system pump (i.e., a non-Condensate pumps).
HHVP+HBC=As-Fired fuel enthalpy (Heat Value+Firing Correction) for fossil combustion.
LP=Low Pressure
PWR=Pressurized Water Reactor.
RV=Reactor Vessel.
RVP=Reactor Vessel pump.
SG=Steam Generator.
TC=Turbine Cycle.
TUR=Main steam turbine [the k4^{th} HP or k5^{th} LP stage group], or the Auxiliary Turbine [Aux].
X=Indication of a sub-system [RVP, FWP or CDP], or a steam turbine [TUR].
XX=Indication of a fission release defined in TABLE 3 and discussion; [e.g., XX=REC].
   Subscripts Referencing a Fluid's State Property or Flow [e.g., h_{FW}=>Final FW Enthalpy]:
FW=Final feedwater state exiting the contractual TC.
RCI=Reactor core inlet (downstream from RVI).
RCU=Reactor core outlet (upstream from RV outlet nozzle).
RVI=Reactor Vessel inlet nozzle.
SCI=Steam Generator TC-side coolant inlet to the active heat exchanger region.
STI=Steam Generator TC-side vessel coolant inlet.
TH=Inlet to the TC Throttle Valve.
   Subscripts Referencing Differences Between Quantities [e.g., Δh_{RCX}=h_{RCU}−h_{RCI}]:

$$RCX [ = ] RCU - RCI$$

$$RCY [ = ] RCI - RVI$$

$$SCY [ = ] SCI - STI$$

$$TCQ [ = ] TH - FW$$

### Meaning of Terms

The term “Operating Parameters” used within the general scope and spirit of the present invention, is broadly defined as common off- and on-line data obtained from a thermal system. It includes a set of Off-Line Operating Parameters and a set of On-Line Operating Parameters. These terms are also discussed in '822, in the context of its NCV Model, in Col.15, Line 38 to Col.17, Line 31; and in Col.52, Lines 28-45; and elsewhere in '822. These terms share the same meaning when employed for fossil-fired power plants (for a visual explanation of Operating Parameters applicable for the Input/Loss Method see '429, FIG. 19 and its associated discussion. The terms “thermal system” and “thermal engine” both describe any collection of equipment which: 1) is hot relative to its local environment, and 2) produces a useful output such as an energy flow for space heating, and/or shaft power (e.g., driving a turbine-generator set); and 3) may be applied to traditional power plants, pumps, turbines, heat exchangers, and the like. The term “nuclear engine” refers to a thermal engine based on nuclear fission or fusion. The term “fossil engine” refers to a thermal engine based on the combustion of fossil fuels (e.g., fossil-fired, fossil-fired engine, etc.). The term “condenser” is a hardware device which condenses a fluid to its liquid state so that it can then be economically pumped to a higher pressure and returned to a heating device resulting in production of a useful output. It is used in the Regenerative Rankine Cycle, which was developed during the industrial revolution and used with all nuclear and fossil-fired power plants. For all thermal engines: the term f[(T_{Ref}/T_{Surf-Corr})Q_{Loss}] is herein defined as a “Carnot Reversibility”; the term f[(mT_{Ref}Δs)ᵢᵢ] is defined as “Component Entropy Flow(s)”; and the [m_{RV}T_{Ref}Δs_{RCX}] and Σ_{SG}(\dot{m}T_{Ref}Δs)ᵢ terms define, respectively, a nuclear and fossil-fired generated “System Entropy Flow” (algebraically termed \dot{S}_{Nucl} and \dot{S}_{Foss-SG}).

### The Energetic Engine

The Exergetic Engine is applicable for the analysis of a shell and tube heat exchanger or for a thermal device with heat loss to the local environment. It is obvious that the true thermodynamic irreversibility describes any shell and tube heat exchanger as a complete component, both shell and tube states and flows are known; e.g., a condenser interfacing with both a LP turbine's exhaust and its tertiary circulatory cooling system. However, there are numerous examples of shell- or tube-side exchangers, with heat losses to the environment, which must be analyzed not isolation but either as a shell- or tube-side only. Such examples include: a condenser whose working fluid is the shell-side (its tube-side being outside the Turbine Cycle's system boundary); the tube-side of a fossil-fired Steam Generator whose shell-side contains combustion gases (and outside the boundary). Miscellaneous heat exchangers within the system such as feedwater heaters, the Moisture Separator Reheater used in nuclear power plants and similar exchangers are treated as complete components. The following development describes a complete component (using a condenser as a generic component), followed by shell- or tube-side analysis.

When monitoring a condenser on-line, experience suggests that the only reliable parameters include: a computed heat rejection Q_{REJ} (based on '822 NCV), the measured condenser pressure P_{Cond} and the condenser effectiveness ε_{Cond}. The Second Law thermal efficiency is termed “effectiveness,” ε_{Cond}=−mΔg_{Tube}/Σ_{Shell} mgₖ, is assumed known based on design, verified testing, and/or can be resolved using NCV's Verification Procedures (see '822). Historically it has been found from testing power plants that large commercial condenser ε_{Cond} values are remarkably consistent as a function of P_{Cond} (provided fouling has reached a steady condition). This said, individual condenser exergy flows are simply not knowable with any reasonable accuracy. This statement includes: the turbine's last stage exhaust state and mass flow; return drain flows including feedwater drains, turbine seals and the like; hot-well outlet mass flow; and is especially true for the condenser's tube-side conditions. Tube-side mass flow, and even fluid temperatures, are difficult to measure with any accuracy given very large pipes having stratified flow given no mixing, and without cross-pipe temperature measurements, etc.

Application of Second Law exergy analysis to the nuclear system creates subtle interpretations when using an Exergetic Engine versus the classic Carnot Engine . . . all such interpretations arise from the development of the nuclear Fixed T_{Ref}. Given application of Second Law exergy analysis, the Exergetic Engine produces the same numerical irreversible loss as the classic, provided both use the same T_{Ref}, and a ΔT_{Corr}=0.0 (explained below); however, one needs to keep in mind the following underlying (and quite different) assumptions:
All heat exchanger shell-side exergy flows are used to develop a ΔT_{Corr} which corrects the shell's T_{Hot}, thus allowing equivalence between Eq.(1) and a Carnot Engine.
For a complete component, the physical heat exchanger is theoretically split into individual shell and tube portions, each of these interfacing with an Exergetic Engine processing +Q_{RE}J for the shell-side and processing −Q_{REJ} for the tube.
It is asserted that descriptions of Carnot's cyclic processes are unnecessary contrivances. The nuclear Exergetic Engine has no thermal reservoir, as it simply converts Q_{REJ} to reversibilities and irreversibilities, done isothermally and adiabatically; thus for both shell and tube: Q_{REJ}=|I_{Shell}+R_{Shell}|=I_{Tube}+R_{Tube}|.
The improved accuracy of the condenser's thermal performance is achieved by applying the Exergetic Engine to compute condenser reversibilities which are then compared to the System Entropy Flow (defined below) for identification of degradations arising from any thermal engine.
The Exergetic Engine is also applicable for determining a highly accurate irreversibility loss associated with an individual shell- or tube-side with a convective and/or radiative heat loss to its environment.
An Exergetic Engine can never be applied to nuclear radiation which is not captured by the system; loss power and reversible concepts if applied to such radiation have no meaning.
The nuclear Fixed T_{Ref}, as based on the Inertial Conversion Factor (Ξ), has meaning simply as a coupling mechanism between First and Second Law loss types; i.e., energy flows dispersed to the local environment and Second Law irreversible losses. Indeed, if T_{Ref}≠f(Ξ) for the nuclear system, then both Laws fail when describing a thermal engine.

In summary, application of the Exergetic Engine to a nuclear condenser means using a Fixed T_{Ref} defined by Eq.(10) in '822. Application of the Exergetic Engine to a fossil condenser means using a Floated T_{Ref}. Application of the Exergetic Engine to an isolated Turbine Cycle means using either a Fixed T_{Ref} or Floated T_{Ref} dependent on its G_{IN} source. The fossil engine's calorimetric temperature (T_{CAL}) is fixed by the analyst computing a gaseous fuel's Heat of Combustion, or by the laboratory technician operating a bomb calorimeter; if not properly used, valid First and Second Law fossil analyses are bogus.

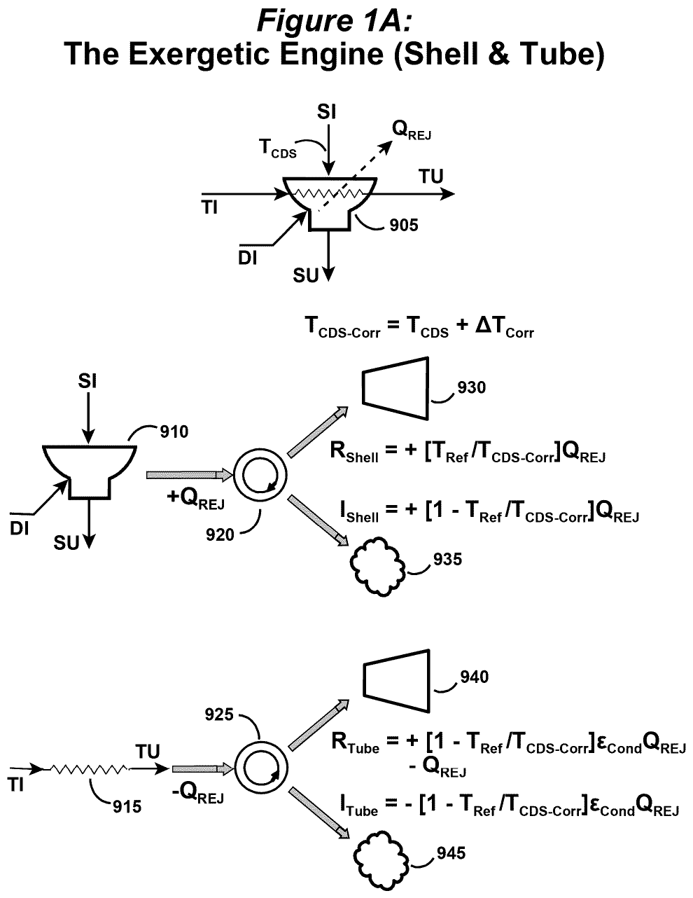

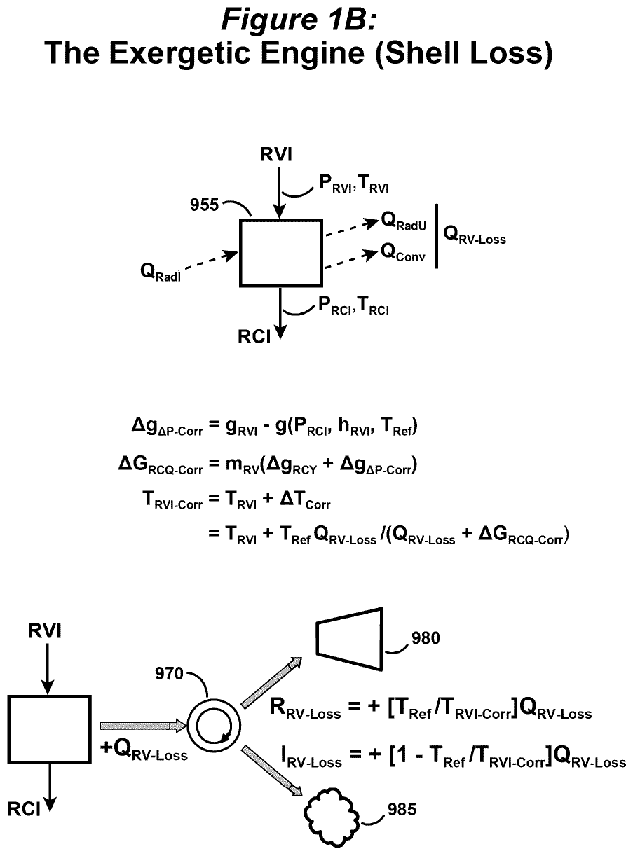

As FIG. 1A suggests, two Exergetic Engines are placed, separately, between the shell loss and the tube gain, each processing Q_{REJ}. In FIG. 1A: TI & TU refer to tube inlet & outlet states and flow; SI, SU and DI are shell-side inlets, outlet and return drain inlet states and flows. T_{CDS} is the saturation temperature as a f(P_{Cond}), traditionally it is defined as Carnot's T_{Hot}; T_{CDX} is the corrected shell temperature (defined below). It is assumed that the condenser vessel proper has no appreciable convective loss. Note that the Exergetic Engine is acquiring a +Q_{REJ} as an input, converting to R_{Shell} and I_{Shell} which net a +Q_{REJ}, thus a passive construct; the opposite signs apply to the tube-side.

The true thermodynamic irreversibility associated with any heat exchanger is given as the summation of all shell and tube exergy flows, Eq.(1). This expression indicates, for any heat exchanger, that the net of shell-side exergy flows (its absolute value) must always be greater than the tube-side exergy flow gain (i.e., using conventional outlet less inlet); a positive I_{HTX} and thus the exchanger does not violate the Second Law. For convenience, the tube side is assumed to consist of single output and inlet connections.

$${I}_{H T X} ≡ - [ {\sum }_{Shell} {mg}_{k} + m Δ {g}_{T u b e} ] \qquad ( 1 )$$

There is subtlety in Eq.(1) versus the traditional Carnot Engine. Although Carnot's “greatest caloric production” is associated with a maximum temperature difference, the simple prima facie case is that a ΔT_{MAX} has nothing in common with an irreversible loss provided Eq.(1) is not governing. Violate Eq.(1) and one attempts heat transfer from T_{Hot}→T_{cold}. There is no prior art which teaches otherwise. In defense of Carnot, in 1824 the Second Law, irreversible loss, exergy analysis . . . were simply not developed concepts. In the simplest of terms, his Engine's T_{Hot} is corrected to confirm compliance with Eq.(1). For example, the notion that any T_{Cold} (say T_{cold}≥T_{Hot}) can produce a negative loss using the traditional [1−T_{Cold}/T_{Hot}]Q_{REJ}, is, indeed, thwarted by Eq.(1). If the absolute net shell exergy flow is less than the tube-side increase, based on any assumed absolute reference temperature (T_{Cold}), then exchange of energy flow is impossible.

Using Eq.(1) as the standard, the following are developed for an isolated condenser; note well, this development applies to all shell and tube heat exchangers analyzed as complete components. For the case of the isolated heat exchanger the −mΔg_{Tube} term is replaced with [+ε_{Cond} Σ_{Shell} mgₖ]; this substitution eliminates ε_{Cond} when developing ΔT_{Corr} of Eqs.(11) & (16). In addition, it is understood that the expression “summation of exergy flows associated with the heat exchanger's T_{Hot} side” means to use Eq.(2) if describing a shell-side ΔG_{HTX} given its side-side temperature is taken to be T_{Hot} (e.g., a condenser's shell-side inlet is at saturation, its temperature T_{CDS} is the highest seen by the condenser); typically, T_{CDX}=T_{CDS}+ΔT_{Corr}. However, if the exchanger's T_{Hot} is associated with a heat exchanger's tube-side (e.g., a fossil-fired Steam Generator's water-in-tube heat exchangers and its boiler's Drum), then nomenclature reverses: −I_{Tube} ≡ΔG_{HTX} ≡Σ_{Tube} mgₖ; I_{Shell} ≡−Σ_{Tube} mgₖ/ε_{Cond}; and, typically, the corrected T_{Hot} is based on the Drum's saturation temperature.

$${I}_{Shell} ≡ - Δ {G}_{HTX} ≡ - {\sum }_{Shell} {mg}_{k} = + [ 1 - {T}_{Ref} / {T}_{CDX} ] {Q}_{REJ} \qquad ( 2 )$$

$${I}_{T u b e} ≡ + {ε}_{C o n d} {\sum }_{Shell} {mg}_{k} = - [ 1 - {T}_{Ref} / {T}_{C D X} ] {ε}_{C o n d} {Q}_{REJ} \qquad ( 3 )$$

A passive Exergetic Engine leads to derivations of defined reversibilities based on:

$$+ {Q}_{REJ} = + {I}_{Shell} + {R}_{Shell} \qquad ( 4 )$$

$$- {Q}_{REJ} = + {I}_{Tube} + {R}_{Tube} \qquad ( 5 )$$

$${R}_{Shell} = + [ {T}_{Ref} / {T}_{CDX} ] {Q}_{REJ} \qquad ( 6 )$$

$${R}_{T u b e} = + [ 1 - \frac{{T}_{Ref}}{{T}_{CDX}} ] {ε}_{C o n d} {Q}_{REJ} - {Q}_{REJ} \qquad ( 7 )$$

And, finally, summation of total irreversibilities and reversibilities for an isolated condenser:

$${I}_{Cond} = {I}_{Shell} + {I}_{Tube} = + [ 1 - \frac{{T}_{Ref}}{{T}_{CDX}} ] ( 1 - {ε}_{C o n d} ) {Q}_{REJ} \qquad ( 8 )$$

$${R}_{Cond} = {R}_{Shell} + {R}_{Tube} = + [ \frac{{T}_{Ref}}{{T}_{CDX}} ] {Q}_{REJ} + [ 1 - \frac{{T}_{Ref}}{{T}_{CDX}} ] {ε}_{C o n d} {Q}_{REJ} - {Q}_{REJ} \qquad ( 9 A )$$

$$= - [ 1 - \frac{{T}_{Ref}}{{T}_{CDX}} ] ( 1 - {ε}_{C o n d} ) {Q}_{REJ} \qquad ( 9 B )$$

To correct how the Carnot Engine, developing the Exergetic Engine, is based on Eq.(1) by solves for T_{HOT} via Eq.(8) less Eq.(10) for a ΔT_{Corr}; i.e., T_{CDX}=T_{CDS}+ΔT_{Corr}+459.67. Note that Q_{HTX} is used to emphasize that: Q_{HTX} ≡Σ_{Shell} (mh)ₖ in Eq.(11); i.e., the denominator in Eq.(11) could be written as: [T_{Ref} Σ_{Shell} (mS)ₖ]. Q_{REJ} is strictly defined as the energy flow interfaced with the local environment; for a single-sided Exergetic Engine: Q_{REJ}=Q_{HTX}.

$${I}_{C o n d} = [ 1 - \frac{{T}_{Ref}}{{T}_{CDX}} ] {Q}_{REJ} + {ε}_{C o n d} {Q}_{RBJ} \qquad ( 10 )$$

$$Δ {T}_{C o r r} ≡ [ {T}_{Ref} {Q}_{HTX} / ( {Q}_{HTX} + Δ {G}_{HTX} ) ] - ( {T}_{CDS} + 459.67 ) \qquad ( 11 )$$

Although Eq.(11) is universal its ΔG_{HTX} is applicable for shell-side pressure drops correction.

In summary, achieving high accuracy when monitoring an isolated condenser (i.e., any heat exchanger which involves both shell and tube) means employing Eq.(12). Eq.(12) is appropriate for either on- or off-line monitoring. Eq.(12) assumes that tube-side conditions are typically highly uncertain and that the shell-side has no pressure drop (i.e., a saturated condition is found in the shell, T_{CDS}). Note that once ΔT_{Corr} is determined, Eq.(12) is not dependent on mass flow.

$${I}_{C o n d} = [ 1 - {T}_{Ref} / ( {T}_{CDS} + Δ {T}_{C o r r} + 459.67 ) ] ( 1 - {ε}_{C o n d} ) {Q}_{REJ} \qquad ( 12 )$$

This development also applies to a simple convective and/or thermal radiative heat loss from the shell-side (or separately from the tube-side) of any heat exchanger which has an internal flow of fluid and exchanges heat with its environment; i.e., given changes in the fluid's shell-side thermodynamic state. An obvious example is the condenser when analyzed as part of a defined Turbine Cycle (the condenser's tube-side is outside the system). The same principles hold as presented, but using only the shell-side; i.e., FIG. 1B and use of a single Exergetic Engine. A statement of the shell-side irreversible loss, based on Eqs.(1) & (2) becomes:

$${I}_{C o n d - Shell} = [ 1 - {T}_{Ref} / ( {T}_{CDS} + Δ {T}_{C o r r} + 459.67 ) ] {Q}_{R B J} \qquad ( 13 )$$

When analyzing the environmental loss from the shell-side of a heat exchanger (e.g., a nuclear Steam Generator with Q_{SG-Loss} from its outer flow annulus), thus ΔT_{SCY}≠0.0 and with pressure drop, ΔP_{SCY}, the following correction is applied: Δg_{ΔP-Corr}≡[g_{STI}−g(P_{SCI}, h_{STI}, T_{Ref})] Note: ΔT_{SCY}=T_{SCI}−T_{SGI}; etc. The correction, Δg_{ΔP-Corr}, eliminates pressure drop effects which must be treated separately. Of course, any ΔP is an irreversible loss, but cannot be allowed to mask Eq.(1) heat exchanger effects. Note that the inlet T_{STI} is used as the base for correcting temperature; given ΔT_{Corr} is f(Q_{SG-Loss}) and means the outlet T_{SCI} will, of course, vary with Q_{SG-Loss}. Thus, it is convenient to correct a constant T_{STI} (for most SG taken as T_{FW}) providing a variable ΔT_{Corr}, [symbol] _{SG} is the fraction of energy flow delivered to the SG from its source (fossil combustion or nuclear core power) resulting in an environmental loss (Q_{SG-Loss}); the TC suffers a ( [symbol] _{SG}−1) reduction in delivered energy flow.

For the nuclear SG:

$$Δ {G}_{HTX - Corr} = {m}_{F W} ( Δ {g}_{S C Y} + Δ {g}_{Δ P - C o r r} ) \qquad ( 14 A )$$

$${Q}_{S G - L o s s} ≡ {m}_{R V} ( Ξ Δ {g}_{RCX} + Δ {h}_{RVP} ) \qquad ( 15 A )$$

For the fossil-fired SG [T_{STI}=f(P_{Drum})]:

$$Δ {G}_{HTX - C o r r} = {\sum }_{T u b e} {mg}_{k} \qquad ( 14 B )$$

$${Q}_{SG - Loss} ≡ {m}_{A F} ( HHVP + HBC ) \qquad ( 15 B )$$

To summarize both nuclear and fossil:

$$Δ {T}_{C o r r} = [ {T}_{Ref} {Q}_{S G - L o s s} / ( {Q}_{S G - L o s s} + Δ {G}_{HTX - C o r r} ) ] - ( {T}_{STI} + 459.67 ) \qquad ( 16 )$$

$${I}_{S G - L o s s} = [ 1 - {T}_{Ref} / ( {T}_{STI} + Δ {T}_{C o r r} + 459.67 ) ] {Q}_{SG - Loss} \qquad ( 17 )$$

This same technique is applicable to the Reactor Vessel (RV) in which its Q_{RV-Loss} consists of convection, thermal radiation and heating effects from nuclear radiation. Beta (β) and associated Bremsstrahlung radiation is spent between the peripheral fuel assemblies and the inner core shell. Gamma (γ) and ¹n₀ heating of RV structures between the peripheral fuel assemblies and the outer RV vessel has import. Such heating can be computed using well-established art (e.g., S. Glasstone & A. Sesonske, Nuclear Reactor Engineering, D. Van Nostrand Co, NY, 1963; pp. 614-616.). However, the recommended procedure is a combination of analytics and thermography to determine Q_{RV-Loss}. This will indicate whether the ΔExergy Flow associated with fission's mass defect effects, generated from peripheral fuel assemblies, will impact the computed average nuclear power, m_{RV}Δg_{RCX}. If analytics indicate minimal nuclear radiation effects, convection loss may still invoke a Q_{RV-Loss}>0.0 as detected from thermography. In either case if Q_{RV-Loss}>0.0 affects from ΔP_{RCY}>0.0 are applicable and correct must apply: Δg_{ΔP-Corr}≡[g_{RVI}−g(P_{RCI}, h_{RVI}, T_{Ref})] with application of the nuclear Eqs.(14) thru (17) to the Reactor Vessel.

$${I}_{R V - L o s s} = [ 1 - {T}_{Ref} / ( {T}_{RVI} + Δ {T}_{C o r r} + 459.67 ) ] {Q}_{RV - Loss} \qquad ( 18 )$$

### System Entropy Flow

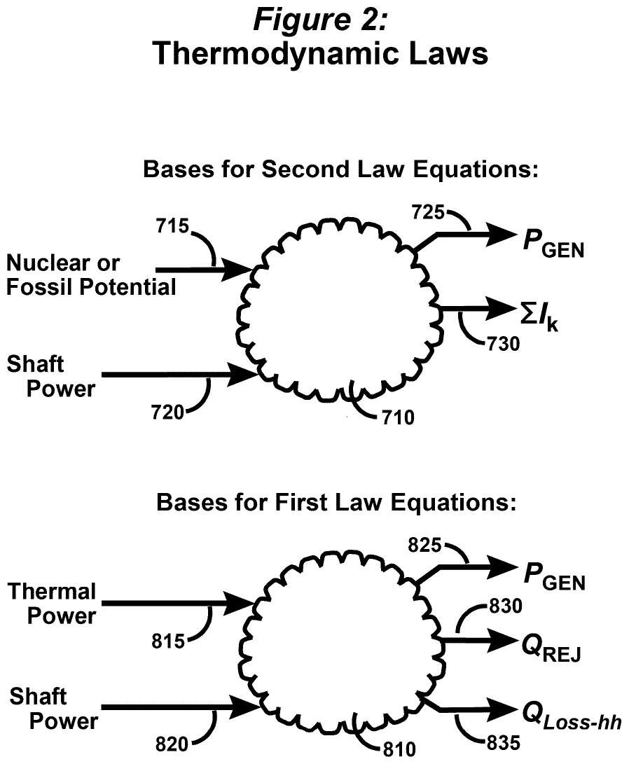

FIG. 2 is based on '822 FIG. 6. Its Second law representation is modified to indicate that Gm for both nuclear and fossil-fired power is formed from their thermodynamic potentials to make actual shaft power, plus shaft powers (e.g., pumps and fans shaft power) entering the system. The objective of '822 was the evaluation different loss types, environmental energy flows versus irreversibilities. This disclosure's objective is to evaluate differences between the two laws of thermodynamics resulting in system Entropy Flows and reversibilities: First Law conversation of energy flows less Second Law exergy analysis. Initial results may appear similar to '822, but end usage differ considerably.

For the nuclear engine, '822 Eq.(1ST) less a corrected Eq.(2ND) is given as Eq.(19). Note that the first four Carnot Reversibility terms on the right-side reflect the teachings herein (given T_{Hot} and Carnot Reversibilities are now corrected).

$${C}_{E} {V}_{Fuel} {\overline{\sum }}_{F} {\overline{υ}}_{REC} {Φ}_{TH} ( Ξ - 1 ) = ( {T}_{Ref} / {T}_{RVI - Corr} ) {Q}_{RV - Loss} + ( {T}_{Ref} / {T}_{STI - Corr} ) {Q}_{SG - Loss} + ( {T}_{Ref} / {T}_{T C - C o r r} ) {Q}_{TC - Loss} + ( {T}_{Ref} / {T}_{CDS - Corr} ) {Q}_{REJ} + \int {d ( mg )}_{T C} + \int {d ( mg )}_{S G} - {( m {T}_{Ref} Δ s )}_{TUR - Aux} - {\sum }_{P u m p} {( m {T}_{Ref} Δ s )}_{k} - {\sum }_{TUR - HP} {( m {T}_{Ref} Δ s )}_{k} - {\sum }_{TUR - L P} {( m {T}_{Ref} Δ s )}_{k} \qquad ( 19 )$$

The left-side of Eq.(19) is f(Φ_{TH}Σ̅_{F}υυ̅_{REC}Ξ) via Eq.(1ST) the thermal power (m_{RV}Δh_{RCX}), less f(Φ_{TH}Σ̅υ̅_{REC}) via Eq.(2ND) the nuclear power (m_{RV}Δg_{RCX}); thus reducing to a statement of the nuclear power plant's System Entropy Flow. The first term on the right-side is described by Eq.(18); the second term by Eq.(17); the third following Eq.(13) where T_{TC-Corr} is defined by: T_{TC-Corr}=T_{TC-Loss}+ΔT_{Corr} where T_{TC-Loss} is defined by Eq. (15) in '822. The fourth term on the right-side is the condenser's +Q_{REJ} less Eq.(13), based on Eq.(11) given Q_{REJ}=Q_{HTX}, via [Q_{REJ}−I_{Cond}=Q_{REJ}+R_{Cond}], both sides producing a f[(T_{Ref}/T_{CDX})Q_{Loss}] term. Note that an un-capitalized “entropy flows” term is defined generically as all non-Carnot Reversible terms found in Eqs.(19) or (22); a capitalized “Entropy Flows” refers to combined System Entropy Flow and Component Entropy Flows. Rearranging Eq.(19):

$$\begin{matrix}{m}_{R V} {T}_{Ref} Δ {s}_{R C X} = {C}_{E} {V}_{Fuel} {\overline{\sum }}_{F} {\overline{υ}}_{REC} {Φ}_{T H} ( Ξ - 1 ) & \\ = + {\sum }_{h h} f ( {T}_{Ref} / {T}_{Surf - Corr} ) {Q}_{Loss - hh} - {\sum }_{i i} {( m {T}_{Ref} Δ s )}_{i i} & ( 21 )\end{matrix} \qquad ( 20 )$$

The fossil-fired power plant's First Law less Second Law produces the same terms found on the right-side of Eq.(19), less Q_{Loss-RV} but plus an Intermediate Pressure Turbine term. As discussed in the BACKGROUND, for the fossil engine the left-side of an Eq.(19)-like expression is more complex given G_{IN} is more complex. The following Eq.(22) is a First Law less Second Law description; note that input pump and fan powers less Σ(mΔg)_{Pump+Fan} results in entropy flows.

$${\sum }_{SG} {( \dot{m} {T}_{Ref} Δ s )}_{i} = ( {T}_{Ref} / {T}_{STI - Corr} ) {Q}_{Loss - SG} + ( {T}_{Ref} / {T}_{TC - Corr} ) {Q}_{Loss - SG} + ( {T}_{Ref} / {T}_{CDS - Corr} ) {Q}_{REJ} + \int {d ( mg )}_{SG} + \int {d ( mg )}_{TC} - {( {mT}_{Ref} Δ s )}_{TUR - Aux} - {\sum }_{Pump + Fan} {( {mT}_{Ref} Δ s )}_{k} - {\sum }_{TUR - HP} {( {mT}_{Ref} Δ s )}_{k} - {\sum }_{TUR - IP} {( {mT}_{Ref} Δ s )}_{k} - {\sum }_{TUR - LP} {( {mT}_{Ref} Δ s )}_{k} \qquad ( 22 )$$

Eq.(22) can be reduced in similar fashion as done with the nuclear engine, resulting in Eq.(23). However, understand that the condenser's impact on the fossil engine is the objective, the fossil engine analytics are reduced by eliminating the combustion process, describing only the working fluid as the confining system. Thus, Eq.(22) is greatly simplified by only analyzing the result of combustion energy flow delivered to the Steam Generator's working fluid (tube-side). Such analysis includes: main steam routing, reheat, spray flows and soot blowing energy flows. A simulation of the fossil-fired Steam Generator is conveniently obtained by using Exergetic Systems® EX-FOSS simulator in combination with the EX-SITE computer simulator of Turbine Cycles (these software products are available from www.ExergeticSystems.com). First less Second Law descriptions, result in tube-side entropy flows found throughout the Steam Generator, and producing a fossil System Entropy Flow, Σ_{SG} (\dot{m}T_{Ref}Δs)ᵢ:

$${\sum }_{SG} {( \dot{m} {T}_{Ref} Δ s )}_{i} = + {\sum }_{hh} f ( {T}_{Ref} / {T}_{Surf - Corr} ) {Q}_{Loss - hh} - {\sum }_{ii} {( {mT}_{Ref} Δ s )}_{ii} \qquad ( 23 )$$

It is obvious that the Carnot Reversibility term of Eq.(23) defines the summation of SG and TC Entropy Flows; thus the System Entropy Flow results from a few Carnot Reversibilities terms, less the summation of, typically, hundreds of Component Entropy Flows.

Allow generalized notation in which the left-side of Eq.(20) and the left-side of Eq.(23) are respectively termed \dot{S}_{Nucl} and \dot{S}_{Foss-SG}, and herein defined as their “System Entropy Flow” for the nuclear and fossil-fired power plant. These are further generalized by the symbol \dot{S}_{SYS} which is viewed as a generic System Entropy Flow. Dividing Eqs.(21) and (23) by SYS results:

$$1. = + [ {\sum }_{hh} f ( {T}_{Ref} / {T}_{Surf - Corr} ) {Q}_{Loss - hh} / {\dot{S}}_{SYS} ] - [ {\sum }_{ii} {( {mT}_{Ref} Δ s )}_{ii} / {\dot{S}}_{SYS} ] \qquad ( 24 A )$$

Eq.(24) has advantage when describing a fossil engine given its simplicity in presenting a unique thermodynamic understanding. However, Eqs.(21) and (23) also can be presented by equating Carnot Reversibilities to the summation of all Entropy Flows.

$${\sum }_{hh} f ( {T}_{Ref} / {T}_{Surf - Corr} ) {Q}_{Loss - hh} = {\dot{S}}_{SYS} + {\sum }_{ii} {( {mT}_{Ref} Δ s )}_{ii} \qquad ( 24 B )$$

To twist the Second Law, Eq.(24B) states that Carnot Reversibilities must be solely responsible for all Entropy Flow gains seen by the thermal engine. Or, to simplify, an analyst may add \dot{S}_{SYS} and Component Entropy Flows, resulting principally in the condenser's Carnot Reversibility. Eq.(24B) simply emphasizes proper treatment of the condenser and its use of the Exergetic Engine (i.e., R_{Cond-Shell}) for demonstrating an improved power plant thermodynamic understanding based on entropy flows.

Further, Eqs.(21) and (23) are important as they also suggest that instead of laborious computations of individual Component Entropy Flows—the Turbine Cycle containing hundreds of components, not all well understood—they can be used to independently solve Σᵢᵢ(mT_{Ref}Δs)ᵢᵢ terms given the Carnot Reversibilities consist of only the first four terms in Eq.(19), and three in Eq.(22).

$${\sum }_{ii} {( {mT}_{Ref} Δ s )}_{ii} = + {\sum }_{hh} f ( {T}_{Ref} / {T}_{Surf - Corr} ) {Q}_{Loss - hh} - {\dot{S}}_{SYS} \qquad ( 25 )$$

Note, that for the nuclear engine, Q_{REJ} and Reactor Vessel flow, m_{RV}, are computed based on NCV Methods. For the fossil engine, Q_{REJ} and Feedwater flow, m_{FW}, are computed and/or verified based on Input/Loss Methods noting that EX-FOSS software and a TC simulator are important conveniences.

The worth of these techniques cannot be overstated. For 80 years, since Fermi (in 1937) and Keenan (in 1941) first developed the availability (exergy) concept, thermodynamicists the world over taught that a fossil engine's heat rejection, thermodynamically, is “worth very little” (this inventor included). Indeed, condensing low pressure steam results in a FFCI_{Cond} of 32.51 when considering the complete fossil system's total G_{IN} (fuel, combustion air, working fluid, etc.), or 74.27 if just considering an isolated SG; see TABLE 2B. The nuclear system FCI_{Cond} is 155.27, see TABLE 1D; the nuclear condenser being at ≈5 times more sensitive than the fossil-fired condenser. This, of course, versus a 60 to 70% energy flow loss via both systems' heat rejection. As Eqs.(21) & (23) numerically demonstrate that the attitude of fossil thermodynamicists is wrong headed. Yes, the nuclear condenser's irreversibility is still small; but inherently, this also means its Carnot Reversibility can be five to six times that of Component Entropy Flows; demonstrated below. Given Eq.(24)'s \dot{S}_{SYS} is known with high accuracy for the nuclear system, this leads to understanding system losses which are reduced to the condenser's Carnot Reversible term plus a few others (having minor import). Note, the NCV Method computes the four system parameters: Φ_{TH}>P_{GEN},Q_{REJ} and m_{RV}, plus a computed nuclear Fixed T_{Ref}; thus, resolving system uncertainties means understanding condenser losses (with unusual precision), with minor RV and SG vessel losses and miscellaneous convective TC losses. The fossil system is less sensitive (justifying, in part, historic bias) but, as taught herein, focus must be had on its condenser Carnot Reversibility for improved system understanding.

As Eqs.(21), (23) & (24A) suggest, Carnot Reversible terms are equal to the sum of Entropy Flows, and numerically swamp the sum of Component Entropy Flows. Note that System Entropy Flows, especially \dot{S}_{Nucl}, can be determined with high accuracy. In summary, action to be taken for the nuclear engine includes: measure the core's entropy and enthalpy rise; use NCV to determine RV coolant flow, Q_{REJ}, etc.; analyze the system using Eqs.(20) & (21); thus resulting in the analyst having an improved understanding of his/her system. In summary, for the fossil engine (or any Steam Generator): determine the thermal load and an estimated G_{IN} or preferably, use Steam Generator and Turbine Cycle simulators; determine FFCIs based on highly accurate Carnot Reversibilities and analyze the system using Eq.(24); then use Input/Loss Methods to verify results using one or more of the four testing methodologies.

### Verification of a Nuclear Engine's Entropy Flows

It is obvious that Eqs.(20) & (21) describe a nuclear engine's Entropy Flows and Carnot Reversibilities. The nuclear core's increase in Entropy Flow is demonstrated to be (Ξ−1) times nuclear power; where Ξ is based on neutrino and total MeV release. Δg_{RCX} is based on a Fixed T_{Ref} determined using Eq.(10) of '822. This is a verification test on measured core inlet and outlet state properties and on the Fixed T_{Ref} determined as based on an assumed burnup (MWD/MTU).

$$( Ξ - 1 ) = {m}_{RV} {T}_{Ref} Δ {s}_{RCX} / ( {m}_{RV} Δ {g}_{RCX} ) \qquad ( 26 )$$

Obviously the RV coolant flow terms either cancel, or can be used for trending a computed m_{RV}(t) over time if exercising Eq.(30C). The term [T_{Ref}Δs_{RCX}/Δg_{RCX}], and its equivalence [m_{RV}T_{Ref}Δs_{RCX}/(m_{RV}g_{RCX})] which is the ratio of \dot{S}_{Nucl} to nuclear power, is herein defined as the “\dot{S}_{Nucl} Ratio”.

To further extend the usefulness of Eq.(26), it is to be noted that (Ξ−1) is unique for any given initial fissile loading. For example, for the common ²³⁵U reactor, as the fission engine produces power, its ²³⁵U loading is depleted while ²³⁹Pu and ²⁴¹Pu are built up. Examination of '822 TABLE 3 indicates that for a virgin (un-irradiated) ²³⁵U system, that (Ξ_{U235}−1)=0.917144. For the pure Pu isotopes: (Ξ_{Pu239}−1)=0.934705, and (Ξ_{Pu241}−1)=0.920681. Thus, if the fission engine is initially loaded with ²³⁵U, the (Ξ−1) quantity as based on measured thermodynamic properties across the nuclear core, can never be less than that associated with ²³⁵U. This statement must be modified given the fission of ²³⁸U, but typically it has a second order affect given its depletion creates Pu. Therefore, for verification of a reactor vessel fluid measurements, confirmation of the reactor's burnup (MWD/MTU), and most importantly verification of Eq.(21)'s Carnot Reversibilities and Entropy Flows, the following is governing for a ²³⁵U system:

$${[ {T}_{Ref} Δ {s}_{RCX} ( t ) / Δ {g}_{RCX} ( t ) ]}_{U 235} \geq ( {Ξ}_{U 235} - 1 ) \qquad ( 27 A )$$

$$\geq 0.917144 \qquad ( 27 B )$$

Application of the concept underlying Eq.(26) also has obvious flexibility as it can be applied to other fission systems. For example, a Thorium (²³²Th) reactor will breed fissile ²³³U, whose (Ξ_{U233}−1)=0.932374. Given an initial seeding of highly enriched ²³⁵U, with minimum ²³⁸U, the lower (Ξ_{U235}−1) value will then off-set an even slight Pu production; the following verification of core thermal properties associated with a Thorium reactor is then governed by:

$${[ {T}_{Ref} Δ {s}_{RCX} ( t ) / Δ {g}_{RCX} ( t ) ]}_{U 233} \leq ( {Ξ}_{U 233} - 1 ) \qquad ( 28 A )$$

$$\leq 0.932374 \qquad ( 28 B )$$

If a Thorium reactor employs moderately enriched ²³⁵U then (Ξ−1) must be weighted. For a molten salt Thorium reactor, using continuous re-fueling, Eq.(28) must be modified with mass flows bearing fissile material which address core retention times.

Further, for a fast reactor breeding ²³⁸U in which its average neutron flux is developed from a mixture of thermal ²³⁵U and some fast ²³⁸U fissions, then the following average Ξ̅ would apply; note that: Ξ_{U238}=1.900587.

$$\overline{Ξ} ( t ) = [ {Ξ}_{U 235} {\int }_{0.02 eV}^{040 eV} {( {V}_{Fuel} {\overline{\sum }}_{F} {\overline{υ}}_{REC} )}_{U 235} d {Φ}_{TH} ( t ) + {Ξ}_{U 238} {\int }_{1 MeV}^{20 MeV} {( {V}_{Fuel} {\overline{\sum }}_{F} {\overline{υ}}_{REC} )}_{U 238} d {Φ}_{TH} ( t ) ] / [ {m}_{RV} ( t ) Δ {g}_{RCX} ( t ) / {C}_{E} ] \qquad ( 29 A )$$

$${[ {T}_{Ref} Δ {s}_{RCX} / Δ {g}_{RCX} ]}_{Breeder} \geq [ \overline{Ξ} ( t ) - 1 ] \qquad ( 29 B )$$

Because the NCV's Core Thermal Power is neutronically dependent, as demonstrated in the above limit tests, a limiting range can also be created for Core Thermal Power, CTP (m_{RV}Δh_{RCX}) and/or its Δh_{RCX}. Assume a conventional ²³⁵U initial fueling, as Pu is created the Inertial Conversion factor will increase in value, described by:

$${\overline{Ξ}}_{U - Pu} ( t ) ≡ \frac{{Φ}_{TH} ( t ) [ {( Ξ {V}_{Fuel} {\overline{\sum }}_{F} {\overline{υ}}_{REC} )}_{U 235} + {( Ξ {V}_{Fuel} {\overline{\sum }}_{F} {\overline{υ}}_{REC} )}_{Pu 239} + {( Ξ {V}_{Fuel} {\overline{\sum }}_{F} {\overline{υ}}_{REC} )}_{Pu 241} ]}{[ {m}_{RV} ( t ) Δ {g}_{RCX} ( t ) / {C}_{E} ]} \qquad ( 30 A )$$

This leads to limits applied for range testing CTP and core fluid state properties:

$${m}_{RV} ( t ) Δ {g}_{RCX} ( t ) {\overline{Ξ}}_{U - Pu} ( t ) \geq [ {m}_{RV} ( t ) Δ {h}_{RCX} ( t ) ] \geq {m}_{RV} ( 0 ) Δ {g}_{RCX} ( 0 ) {Ξ}_{U 235} \qquad ( 30 B )$$

Use of Eq.(30C) addresses changes in the indicated RV coolant flow:

$$Δ {g}_{RCX} ( t ) {\overline{Ξ}}_{U - Pu} ( t ) \geq Δ {h}_{RCX} ( t ) \geq Δ {g}_{RCX} ( 0 ) {Ξ}_{U 235} {m}_{RV} ( 0 ) / {m}_{RV} ( t ) \qquad ( 30 C )$$

Assume a 30% production of nuclear power from Pu, then Eq.(30)'s limits are ranged from 1.92318 [the Ξ̅_{U-Pu}(t) value via Eq.(30A)] to the initial Ξ_{U235} value of 1.917144. The average of this range implies a tolerance on CTP & Δh_{RCX} of ±0.16%, solely based on Ξ̅_{U-Pu}(t), Ξ_{U235} and measured fluid data; this is an order of magnitude improvement over the currently accepted uncertainty of 2.0% in Core Thermal Power; see '822, Col. 2, Lines 54-65.

The above verifications of reactor core thermal properties, as shown by Eqs.(27)-(30), based on Eq.(26), are herein defined as “verification of reactor core thermodynamic properties based on the nuclear T_{Ref} and the Inertial Conversion Factor.” This definition includes the obvious replacement of [T_{Ref}Δs_{RCX}/Δg_{RCX}] with [Δh_{RCX}/Δg_{RCX}] as taught via Eq.(9) in '822, thus comparing directly to Ξ or Ξ̅.

TABLES 1A, 1B and 1C presents computed data associated with a condenser and a Steam Generator servicing a 1270 MWe PWR. TABLE 1A is associated with TABLE 1D. TABLES 1B and 1C demonstrate Eqs.(20) & (21) based on an independent model used for sensitivity study. What is critically important to this disclosure is the realization that balance of Carnot Reversibilities and Entropy Flows, detailed in Eq.(19), etc., intrinsically reduces uncertainty in understanding a nuclear power plant by establishing inequalities about a computed Core Thermal Power.

TABLE 1A
Exergetic Engine Data for a 1270
MWe PWR System and Condenser

| G_{IN} | 68.55817 × 10⁸ | Btu/hr |
|---|---|---|
| m_{RV}Δg_{RCX} | 64.81341 × 10⁸ | Btu/hr |
| Inertial Conversion Factor, Ξ | 1.917144 | |
| ε_{Cond} | 35.22791% | |
| T_{CDS} | 120.51774° | F. |
| ΔT_{Corr} | 0.748967° | ΔF. |
| Q_{REJ} | 81.14990 × 10⁸ | Btu/hr |
| I_{Cond-Shell}, Eqs.(2) & (13) | 10.64529 × 10⁸ | Btu/hr |

In TABLE 1C it is observed that a 1% difference in SG vessel's Q_{SG-Loss}, creates a 1.6% error in the Core Entropy Flow. Note that \dot{S}_{Nucl} is fixed by neutronics and core fluid properties; given its determination, errors made in the core and/or Component Entropy Flows are intrinsically limited. Carnot Reversibilities must equal the summation of Entropy Flows (\dot{S}_{Nucl} and components)! An error in the four nuclear Carnot Reversibility terms (RV, SG, miscellaneous TC losses, and condenser heat rejection) has a six-fold effect on Component Entropy Flows; given errors, individual component values can be driven negative!

TABLE 1B
Base Data for a 1270 MWe PWR Steam Generator

| Ξ m_{RV}Δg_{RCX} | 124.25663 × 10⁸ | Btu/hr |
|---|---|---|
| m_{RV}Δh_{RVP} | 0.84550 × 10⁸ | Btu/hr |
| \dot{S}_{Nucl} = m_{RV}T_{Ref}Δs_{RCX} | 59.44323 × 10⁸ | Btu/hr |
| Δg_{ΔP-Corr} | −0.60046 | Δ° F. |
| T_{STI} | 446.3602° | F. |
| T_{SCI} ( [symbol] = 1.967%) | 432.7409° | F. |

TABLE 1C
Exergetic Engine Sensitivity Data
for a 1270 MWe PWR Steam Generator

| [symbol] _{SG} | Q_{SG-Loss} Eq.(15) | ΔT_{Corr} | I_{SG-Loss} | \dot{S}_{Nucl} Error |
|---|---|---|---|---|
| (%) | (×10⁸ Btu/hr) | (° F.) | (×10⁸ Btu/hr) | (%) |
| 1.0000 | 1.251021 | −3.3283 | 0.551536 | +1.54398 |
| 1.9670 | 2.460759 | −6.7389 | 1.079653 | +0.04875 |
| 2.0000 | 2.502043 | −6.8557 | 1.097584 | −0.05305 |
| 3.0000 | 3.753064 | −10.4056 | 1.638025 | −1.67086 |

TABLE 1D presents a balance of Carnot Reversibilities and Entropy Flows for a 1270 MWe nuclear engine using the methods disclosed. In TABLE 1D, italicized numbers are ratios of Carnot Reversibiilities or Entropy Flows to nuclear power (m_{RV}Δg_{RCX}); used, given that: T_{Ref}Δs_{RCX}/Δg_{RCX}=(Ξ−1).

TABLE 1D
Entropy Analysis of a 1270 MWe PWR System

| | Eq.(27) Calcs | Eq.(26) Calcs |
|---|---|---|
| Component | (×10⁸, Btu/hr) | (×10⁸, Btu/hr) |
| Carnot Reversibility Terms: ^{[a]} | | |
| Reactor Vessel Convection | 0.0000000 | |
| Steam Generator Vessel Convection | 0.0000000 | |
| Miscellaneous Turbine Cycle ^{[b]} | 0.2919223 | |
| Condenser's Exergetic Engine: Q_{REJ} less I_{Cond-Shell} ^{[c]} | 70.5046148 | |
| SUB-TOTAL[Carnot Reversibility/(m_{RV}Δg_{RCX})]^{[d]} | +70.7965371 | [+1.092313] |
| Entropy Flow Terms: | | |
| System Entropy Flow, \dot{S}_{Nucl} = m_{RV}T_{Ref}Δs_{RCX} | 59.4432300 | |
| Reactor Plenum ΔP Losses | −0.1143015 | |
| RV Pump | −0.0764024 | |
| System Piping ΔP Losses | −1.5002901 | |
| Steam Generator Vessel Internals | −3.5269441 | |
| Main HP & LP Turbines ^{[e]} | −4.6218669 | −[+70.7965371 |
| MSR Internals | −0.4775863 | −59.4432300] |
| Auxiliary Turbine | −0.1621345 | |
| TC Feedwater Pumps | −0.0242473 | |
| TC Condensate Pumps | −0.0165848 | |
| Feedwater Heaters ^{[f]} | −0.8619261 | |
| Error in Components ^{[g]} | +0.0289769 | |
| SUB-TOTAL [Comp. Entropy Flows/(m_{RV}Δg_{RCX})] | −11.3533071 | [−0.175169] |
| SUMMATION [T_{Ref}Δs_{RCX}/Δg_{RCX} = Ξ − 1] | +59.4432300 | [+0.917144] |

Notes:
^{[a]} Carnot Reversibilities f[(T_{Ref}/T_{Surf-Corr})Q_{Loss}], associated with RV and SG vessel losses were assumed zero.
^{[b]} Includes only linkage loss between the auxiliary turbine and FW pump.
^{[c]} Based on Q_{REJ} and I_{Cond-Shell} values found in TABLE 1A, i.e., R_{SG-Shell}.
^{[d]}Nuclear power (m_{RV}Δg_{RCX}) used for ratios is found in TABLE 1A, as is G_{IN}.
^{[e]} Last turbine stage's exhaust loss was taken to the UEEP as: m_{L-0}Δg_{L-0}.
^{[f]} A 0.8% Feedwater heater vessel loss was assumed.
^{[g]} Error relative to (m_{RV}Δg_{RCX}) was 0.049%. As argued, serious sensitivity exists; for example, a 10% error in the pressure drops decrease Entropy Flows by 1.58%.

To emphasize the sensitivity of reversibilities to a thermodynamic understanding of the nuclear engine's condenser, consider the difference between the Exergetic Engine versus the classic Carnot Engine by setting ΔT_{Corr}=0.0. This results in a 0.127% change in the nuclear ΔR_{Cond-Shell}, an initial value being 7.0505×10⁸ Btu/hr. For the nuclear engine, numerically the four Carnot Reversible gains are factor of six greater than the total of Component Entropy Flows. If ΔR_{Cond-Shell} is treated as an increase in Component Entropy Flows—in fact the operator, without analyzing Fission Consumption Indices, would be incapable of identifying the degradation—the percentage impact on Component Entropy Flows is potentially 0.722%. Again, this is a six-fold increase in sensitivity; and thus, affects the basic understanding of a nuclear engine. Such sensitivity is not seen in fossil engines. In summary, slight changes in the condenser's Carnot Reversibilities, or slight changes in the monitored FCI_{Cond-Shell}, means an immediate review of all Fission Consumption Indices would be prudent . . . leading to identification of degradations so that corrective actions can be instigated.

Note that TABLE 1D mirrors Eq.(21) in evaluating relative Carnot Reversible gains and Entropy Flow losses. This takes advantage of the uniqueness of the nuclear engine given that: [T_{Ref}Δs_{RCX}/Δg_{RCX}]=(Ξ−1); which is a known constant for a given burnup. If an erroneous ΔR_{Cond-Shell} (given ΔT_{Corr}=0.0) is applied to a back-calculated (Ξ−1), it would vary from 0.917144 to 0.918054, which is equivalent to a burn-up of approximately 6,000 MWD/MTU; a very serious error.

### Verification of a Fossil Engine's Entropy Flows

For the fossil-fired engine, Eq.(22)'s \dot{S}_{Foss-SG} comprises fluid states and flows associated with Σ_{SG} (\dot{m}T_{Ref}Δs)ᵢ, which describes the main steam exchanger, Reheat, sprays, soot blowing, etc. The related term Σ_{SG} (\dot{m}h)ᵢ is the nominator in a statement of the fossil system's thermal efficiency (the SG's output as used to define boiler efficiency, η_{B}). '429 teaches such an efficiency (i.e., the EX-FOSS program), but based on molar terms without dependency on any mass flow. '429 also teaches the calculation of the fuel's heating value (HHPV), g_{Fuel}, etc. based on effluents. This allows the following confirmation of the total thermal load produced from the Steam Generator. Again, for all fossil engines the fuel's reference is T_{CAL} as based on either the analyst's choice when computing gaseous fuel Heat of Combustion, or on the laboratory technician's chosen calorimetric bath temperature. If T_{CAL} is not employed, the analyst is a fool. For the fossil condenser, using a Floated T_{Ref} is common place.

$${\dot{S}}_{Foss - SG} ≡ {\sum }_{SG} {( \dot{m} {T}_{Ref} Δ s )}_{i} = {η}_{B} [ {m}_{AF} ( HHVP + HBC ) ] - {\sum }_{SG} {( \dot{m} g )}_{i} \qquad ( 31 )$$

For a fossil-fired SG complexity abounds; and even if its working fluid is considered in isolation (i.e., Second Law analysis of the combustion process is not considered). Development of ΔT_{Corr} for the working fluid side of the Stean Generator (SG) is a two-step process: first determine the SG's thermal load (Q_{Load}); its Boiler Drum pressure (P_{Drum}) thus its saturation (T_{Drum}); determine (mΔg)ₖ quantities for the working fluid as it travels thru SG heat exchangers; and then calculate I_{SG-Shell} by manipulating Eqs.(2) & (4), leading to ΔT_{Corr}. Note that I_{SG-Shell} relates to the SG as a component and that [Q_{Load}−Σ_{WF} mgₖ] reduces to a working fluid Σ_{WF} (mT_{Ref}Δs)ₖ term which describes any heat exchanger's irreversible loss while heating a fluid.

$${I}_{SG - Shell} = {Q}_{Load} - [ {T}_{Ref} / {T}_{Drum - Corr} ] {Q}_{Load} \qquad ( 32 A )$$

$$= {Q}_{Load} - {\sum }_{WF} {( mg )}_{k} \qquad ( 32 B )$$

$$Δ {T}_{Corr} = [ {T}_{Ref} {Q}_{Load} / {\sum }_{WF} {( mg )}_{k} ] - {T}_{Drum} \qquad ( 33 )$$

$${I}_{SG - Shell} = [ 1 - {T}_{Ref} / ( {T}_{Drum} + Δ {T}_{Corr} ) ] {Q}_{Load} \qquad ( 34 )$$

Although Eqs.(32B) & (34) produce identical results, for routine monitoring at constant load, Eq.(34) avoids Σ_{WF} (mg)ₖ computations. Fossil SG employ high complexity in heat exchanger arrangements and routings of the working fluid. The easiest method of generating Σ_{WF} (mg)ₖ is to use the EX-FOSS SG simulator; for example, convective losses are assigned uniquely to each heat exchanger. Note that water walls have ambient exposure; however, internal exchangers (e.g., the Economizers and Reheater) having no such exposure. ΔT_{Corr} is typically between −40 to −50° ΔF.

TABLE 2A presents numerical results associated with an Exergetic Engine applied to a Steam Generator associated with a fossil-fired power plant.

TABLE 2A
Data for a 600 MWe Coal-Fired Condenser

| | | |
|---|---|---|
| \dot{S}_{Foss-SG} = Σ_{SG} (\dot{m}T_{Ref}Δs)ᵢ | 22.032415 × 10⁸ | Btu/hr |
| Σ_{Shell} (mg)ₖ | −1.926710 × 10⁸ | Btu/hr |
| T_{Ref} = T_{TI} | 71.662600° | F. |
| T_{CDS} | 112.220523° | F. |
| ΔT_{Corr} | 1.152304° | ΔF. |
| Q_{REJ} | 26.470438 × 10⁸ | Btu/hr |
| I_{Cond-Shell}, Eqs. (1), (8) & (10) | 1.926710 × 10⁸ | Btu/hr |

TABLE 2B presents a numerical example of Exergetic Engine equations for a fossil engine, a 600 MWe coal-fired power plant using the Input/Loss Method. In TABLE 213, italicized numbers are ratios relative to the computed System Entropy Flow, Σ_{SG} (\dot{m}T_{Ref}Δs)ᵢ.

TABLE 2B
Entropy Flow Analysis of a 600 MWe Coal-Fired Steam Generator

| | Eq.(25) Calcs | Eq.(23) Calcs |
|---|---|---|
| Component | (×10⁸, Btu/hr) | (×10⁸, Btu/hr) |
| Carnot Reversibility Terms: | | |
| Miscellaneous Turbine Cycle ^{[a]} | 0.0968567 | |
| Steam Generator Convection & Radiation Vessel Loss | 0.4005466 | |
| Condenser's Exergetic Engine: Q_{REJ} less Eq.(13) ^{[c]} | 24.5437286 | |
| SUB-TOTAL (Carnot Reversibilities/\dot{S}_{Foss-SG}) | +25.0411319 | (+1.136559) |
| Entropy Flow Terms: ^{[d]} | | |
| SG System Entropy Flow, \dot{S}_{Foss-SG} ≡ Σ_{SG} (\dot{m}T_{Ref}Δs)ᵢ ^{[e]} | 22.0324145 | |
| System Piping ΔP Losses | −0.3277775 | |
| Main HP & LP Turbines ^{[f]} | −1.9039320 | |
| Auxiliary Turbine ^{[g]} | −0.1808421 | |
| TC Feedwater Pumps, via Aux. Turbine | −0.0701812 | −[+25.0411319 |
| TC Condensate Pumps, Motor | −0.0113891 | −22.0324145] |
| Feedwater Heaters | −0.5084663 | |
| Error in Components (0.028% of \dot{S}_{SG}) | 0.0061292 | |
| SUB-TOTAL (Component Entropy Flows/\dot{S}_{Foss-SG}) | −3.0087174 | (−0.136559) |
| SUMMATION (Carnot Less Comp Entropy Flows/\dot{S}_{Foss-SG})^{[h]} | +22.0324145 | (+1.000000) |

Notes:
^{[a]} Assumed a 0.5% loss from all Feedwater heater vessels.
^{[b]} EX-FOSS analysis assumed an ASME PTC 4 L_{β} loss at 1.50%.
^{[c]} Based on Q_{REJ} and I_{Cond} values, see TABLE 2A.
^{[d]} Based on EX-FOSS (SG) and EX-SITE (TC) simulations of a 2005 System Effects Test, which produced: G_{IN} for the system of 59.27 × 10⁸ Btu/hr, thus a FFCI_{Cond} of 32.51 [G_{IN} for the isolated SG was 25.94 × 10⁸ Btu/hr with a FFCI_{Cond} of 74.28]; the sum of FFCI_{Comb}, FFCI_{Air} & FFCI_{Misc} totaled 562.34 (a huge ineffective waste).
^{[e]} An EX-FOSS Steam Generator analysis produced: individual Component Entropy Flows summing to 22.0324145 × 10⁸ Btu/hr; the same value as Q_{Load} less Σ_{SG} (mg)ₖ for 8 SG heat exchangers plus soot blowing and Drum latent heat.
^{[f]} Last turbine stage's exhaust loss was taken as: m_{L-0}Δg_{L-0}.
^{[g]} The Auxiliary Turbine drives three pump stages: the main FW pump, heat exchanger spray pumps and the DA drain pump.
^{[h]}The summation mirrors Eq.(24B).

To summarize, as explained, if the fossil-fired calorimetric temperature (T_{CAL}) is not used as a thermodynamic basis for all reactants (combustion air, soot blowing, sorbent injection, etc.), then one is guaranteed to violate the First Law. Although T_{CAL} only applies to energy flows supplied to the system, if not properly used all Second Law analyses are also bogus. For the nuclear engine, if the nuclear reference T_{Ref} (a Fixed T_{Ref}), as defined by Eqs.(9) & (10) in '822, is not used, then violation of both laws is guaranteed. For all nuclear and fossil engines, or a isolated Turbine Cycle use of the Exergetic Engine is mandated. Second Law exergy analysis requires a defined T_{Ref}. The nuclear employs the Fixed T_{Ref}. The fossil T_{Ref} maybe determined using several methods:
T_{Ref} maybe chosen as the Condenser's tube-side inlet temperature (the assumed coldest reservoir seen by the fossil engine), thus a Floated T_{Ref}. A minor error will result.
For an isolated Turbine Cycle, the preferred embodiment is to determine T_{Ref} based on an assumption that the condenser's thermal activity ceases. This means all inlet flows to the shell-side are returned to their saturated liquid state at their supplied pressures, and mixed with tube-side inlet conditions. The base concept determines an equilibrium temperature after all streams flow into the same “bucket”. This will produce a corrected temperature close to the tube inlet.

$${T}_{Ref} = ( {P}_{Cond} , {\overline{h}}_{Equil} ) , where : {\overline{h}}_{Equil} = [ {\sum }_{Shell} {( {mh}_{f} )}_{k} + {( mh )}_{TI} ] / [ {\sum }_{Shell} {m}_{k} + {m}_{TI} ] \qquad ( 35 )$$

For the complete fossil-fired system, the preferred embodiment is to determine T_{Ref} based on an assumption that all functional components in the system have cease, having come to an equilibrium state. Fuel firing is eliminated. This means to use an Eq.(35)-like equation but including all non-fuel reactant mass flows, corrected to T_{CAL}, including the condenser's tube-side inlet energy flow. Such mixing involves combustion air, Air Pre-Heater leakage, in-leakage of water, condenser tube-side state and flow, etc. Again, the resultant h̅_{Equil} will produce a temperature close to T_{TI} but without error.

To emphasize the sensitivity of reversibilities to a thermodynamic understanding of a fossil-fired Turbine Cycle, again, set: ΔT_{Corr}=0.0. This results in a 0.079% change in R_{Cond}, a ΔR_{Cond} of 5.895×10⁶ Btu/hr. Numerically, the three Carnot Reversible gains are factor of 5 greater than the total of Component Entropy Flows losses. If ΔR_{Cond-Shell} is treated as an increase in these Entropy Flows—in fact the operator, without analyzing Fossil Fuel Consumption Indices, would not be able to identify the degradation—the percentage impact on Component Entropy Flows is potentially 0.40%. Thus, a 0.08% thermodynamic change in the fossil condenser, could well have a factor of 5 impact on base understanding of a fossil engine. Slight changes in the condenser's Carnot Reversibilities, or changes in the FFCI_{Cond-Shell}, means immediate review of all Fossil Fuel Consumption Indices, thus identification of degradations such that corrective actions are instigated.

### INDUSTRIAL APPLICABILITY

The above DETAILED DESCRIPTION describes how one skilled can embody its teachings when creating viable power plant analyses. This section describes its industrial applicability. That is, how to enable the Exergetic Engine and process system thermal evaluations based on Carnot Reversibilities and Entropy Flows associated with a thermal engine: how to configure its computer (termed the “Calculational Engine”); how to process plant data; how to configure its equations for pre-commissioning and, separately, for routine operations; and, most importantly, presents specific recommendations as to what the plant operator needs to monitor (i.e., to absorb NCV or Input/Loss output information and to act upon that information). In summary the Calculational Engine, as a computer, processes a set of computer instructions, processes input data (e.g., operating parameters, Regulatory Limits, etc.), and processes output data. Such enablement is presented in four sections: Clarity of Terms and Detailed Description of the Drawings. Details of the Calculational Engine and its data processing is discussed in '822 under the same section title.

The applicability of this disclosure includes any heat exchanger which has an energy flow loss to its local environment; the following TABLE 3 summarizes a number of Exergetic Engine applications.

TABLE 3
Uses of Exergetic Engines for Heat Exchangers Interfaced with Their Environments

| Heat Exchanger | Reference | T_{Hot} | | | |
|---|---|---|---|---|---|
| Type and Use | Temperature | Definition | Δg_{ΔP-Corr} | Q_{REJ} | Irreversibility |
| Shell and Tube, non- | Fossil Floated, | Shell | Yes | Local | Eq.(8) with (11) |
| condensing with heat loss. | Nuclear Fixed | Inlet | | | |
| Fossil Steam Generator | Floated | Drum | No | Tube | Eq.(17) w/(14B) |
| tube-side to TC. | | Saturation | | sum. | (15B) & (16) |
| Reactor Vessel heat loss | Fixed | T_{RVI} | Yes | Local | Eq.(18) w/(14A) |
| via outer flow annulus. | | | | | (15A) & (16) |
| Nuclear Steam Generator | Fixed | PWR's | Yes | Local | Eq.(17) w/(14A) |
| heat loss via outer annulus | | T_{STI} | | | (15A) & (16) |
| Fossil condenser shell- | Floated | Shell | No | Shell | Eq.(2) with (11) |
| side heat rejection. | | Saturation | | sum. | |
| Nuclear condenser shell- | Fixed | Shell | No | Shell | Eq.(2) with (11) |
| side heat rejection. | | Saturation | | sum. | |

### Clarity of Terms

The expression “thermal engine” is any device which gets “hot”; i.e., the First and Second Laws of thermodynamics has applicability when describing a thermal engine's flow of energy and exergy in its production of useful output and has a heat rejection process. The term “condenser” is defined as any device used for the heat rejection process. In the context of this disclosure, thermal engine includes the “nuclear engine” and the “fossil engine”. “Nuclear engine” is defined any engine which is sustaining a nuclear fission or fusion reaction, and producing a useful output. “Fossil engine” is defined as engine which is fueled with a hydrocarbon, combusting that fuel, and producing a useful output.

In detail, the expression “Turbine Cycle” (TC) is herein defined as both the physical and thermodynamic boundary of a Regenerative Rankine Cycle. Atypical Turbine Cycle comprises all equipment bearing working fluid including, typically, a turbine-generator set producing electric power, a condenser, pumps, and Feedwater heaters.

The word “instigating” is herein defined as: to cause a deliberate action to occur, said action implemented using voice commands, a physical movement (e.g., turning a valve, pressing a control actuator), written instructions to subordinates, and/or using a programmed computer or using a computer system.

Throughout this disclosure, the expressions “First Law”, “First Law conservation” and like expressions mean the same; that is, an application of the First Law of thermodynamic principles descriptive of the conservation of energy flows within a thermal system. Throughout this disclosure, the expressions “Second Law”, “Second Law exergy analysis” and like expressions mean the same; that is, an application of the Second Law of thermodynamic principles descriptive of an exergy analysis. Exergy analysis describes the destruction of a total exergy flow supplied to a thermal system (G_{IN}), as well as its concomitant creation of useful power output (P_{GEN}) and the set of system irreversible losses (ΣIₖ).

In the context of claiming this invention, the phrase: “analyze a set of paired performance metrics based the power plant's entropy flows and their temporal trends” is defined as comparing temporal trends of a parameter with its computed value based on analysis of System and Component Entropy Flows, taught in this disclosure. Said computed values as associated with Entropy Flows comprise: Inertial Conversion Factor (Ξ) [e.g., as used in Eqs.(26)-(30), Eq.(13), etc.]; component reversibilities [e.g., Eqs.(6) & (7)]; nuclear power [m_{RV}Δg_{RCX}]; thermal power [m_{RV}Δh_{RCX} or m_{RV}Δg_{RCX}Ξ]; the set of Thermal Performance Parameters as appropriate to entropy flows, as defined in '822, Col. 51, Line 42 thru Col. 52, Line 18; and any similar such term. Specific examples of paired performance metrics include: comparing the currently computed Ξ value to its prediction (e.g., for a virgin ²³⁵U comparing to Ξ_{U235}); examining the temporal trend in the computed \dot{S}_{Nucl} Ratio for any change (e.g., plots of the \dot{S}_{Nucl} Ratio versus time, and versus gross generation); examining the temporal trends in Consumption Indices associated with components producing Carnot Reversibilities for any change; and the like

In the context of claiming this invention, the phrase: “analyze the power plant's condenser by correcting its indicated saturation temperature [referring to T_{CDS}] based on the summation of exergy flows associated with the power plant's condenser shell-side, resulting in an Exergetic Engine whose analytics produce a highly accurate irreversible loss” implies, for example, that the power plant operator is given actionable information based on this disclosure, specifically in the form of: temporal trends in the computed I_{Cond-Shell} as based on Eq.(13); temporal trends in the computed R_{Cond-Shell} as based on Eq.(6); temporal trending I_{Cond-Shell} versus condenser pressure P_{Cond}; temporal trending the relative worth of losses using plots of FFCI_{Cond} or FCI_{Cond}; etc.

In the context of claiming this invention, the phrase: “analyze the power plant's heat exchanger by correcting its T_{Hot} based on the summation of exergy flows associated with the power plant's heat exchanger T_{Hot} side, resulting in an Exergetic Engine whose analytics produce a highly accurate Carnot Reversibility” means, for example, that the power plant operator is given actionable information in the form of: temporal trends in the computed heat exchanger's Carnot Reversibilities, R_{HTX}, as based on Eqs.(6) or (7); temporal trends in the resultant I_{HTX}, of Eq.(1), and thus affecting system operations and safety given temporal trends in FFCI_{HTX} or FCI_{HTX}; and the like

In the context of claiming this invention, the expression: “processing analysis of the set of paired performance metrics and supporting technology” is defined as comparing temporal trends of a parameter with its computed value based on analysis of System and Component Entropy Flows as taught in this disclosure.

In the context of claiming this invention, the expressions: “processing the Exergetic Engine's analytics for the power plant's condenser and for supporting technology” and “processing the Exergetic Engine's analytics for the power plant's heat exchanger and for supporting technology” generically mean the same; and defined as comparing temporal trends in computed parameters (such as irreversible losses and/or Carnot Reversibilities) with computed values based on analysis of System Entropy Flow and Component Entropy Flows as taught in this disclosure.

In the context of claiming this invention, the expression: “a set of identified degradations within the power plant” refers to the ability of a well taught methodology to assist in identifying components whose performances are degraded. Of course, power plants consist of hundreds of components, chasing all at once is a rabbit hole. Taught in this disclosure is to concentrate only on the very few Carnot Reversibilities present in any power plant; the condenser having paramount importance. The “how” degradations are identified is accomplished, for example, by first monitoring trends in Consumption Indices associated with components with Carnot Reversibility. For example, an increase in the condenser's Consumption Index should draw immediate attention to any changes in R_{Cond-Shell}, plots of R_{Cond-Shell} versus P_{Cond}, etc. . . . , this is key given the demonstrated sensitivity condenser Carnot Reversibility has on thermodynamically understanding a power plant and its operations. Using changes in R_{Cond-Shell}, given its importance, the operator must then review all Consumption Indices for increases in losses, and thus identify various degradations within the thermal system.

In the context of claiming this invention, the expression: “correcting the set of identified degradations” refers to the power plant operator instigating “corrective” action. For any thermal engine having the complexity of a modern power plant the operator typically has a dozen corrective paths to consider for any given component degradation. Such actions must rely on the operator's experience and knowledge of system components coupled to analytics resulting in computed Carnot Reversibilities and Entropy Flows. For example, if I_{Cond-Shell} or R_{Cond-Shell} has changed then the operator will instigate any one of the following actions given knowledge of their particular condenser: engage additional circulatory water pumps, if available; based on a temporal trend of ambient wet-bulb temperature versus condenser pressure, engage air ejectors (to remove non-condensable gases), and/or engage the condenser's vacuum pumps; correct a high condenser hot well level by opening emergency drain valves; for a following outage, conduct chemically cleaning of the condenser's shell-side and/or clean the inside of condenser tubes; take action to isolate the lowest pressure Feedwater heater to gain a portion of the lost power resultant from a degraded condenser (given that its \dot{m}Δg_{Tube} increase is significantly lower than the average); etc.

As used herein, the root words “obtain”, “determine” and “establish”, and their related derivatives (e.g., “obtaining”, “determining” and “establishing”) are all defined as taking a certain action. The certain action encompasses: to directly measure, to calculate by hand, to calculate using a programmed computer, to authorize calculations using a programmed computer at a facility controlled by the authorizer, to make an assumption, to make an estimate, and/or to gather a database.

As used herein, the words “monitoring” or “monitored” are meant to encompass both on-line monitoring (i.e., processing system data in essentially real time) and off-line monitoring (i.e., computations involving static data). A “Calculational Iteration” or “monitoring cycle” is meant to be one execution of the processes described in '822 FIG. 5, comprising: acquiring data, exercising a mathematical model including matrix solution, minimization analysis, etc.

As used herein, the word “indicated” when used in the context of data originating from the thermal system, is herein defined as the system's actual and uncorrected signals from a physical process (e.g., pressure, temperature or quality, mass flow, volumetric flow, density, and the like) whose accuracy or inaccuracy is not assumed. As examples, a system's “indicated Reactor Vessel coolant mass flow”, or its “indicated Turbine Cycle feedwater mass flow” denotes system measurements, the accuracy of which is unknown (they are “as-is”, with no judgement applied). Such indicated measurements are said to be either correctable or not. It may be that the corresponding computed value tracks the indicated value over time. For example, for the case of an indicated RV coolant mass flow, when used as a SEP, it may be shown that the NCV computed mass flow tracks the indicated flow.

As used herein, the words “programmed computer” or “operating the programmed computer” or “using a computer” are herein defined as the action encompassing either to directly operate a programmed computer, to cause the operation of a programmed computer, or to authorize the operation of a programmed computer at a facility controlled by the authorizer.

The word “understanding”, in context of understanding a thermal system, is herein defined as having gained sufficient comprehension of a power plant that instigated actions taken by the operator result in improved system control and/or improved safety. In the context of this disclosure, a 2.0% uncertainty in nuclear power plants—believed acceptable by the U.S. Nuclear Regulatory Commission—means a 4.0% range in First Law energy flows across the core; i.e., Core Thermal Power. '822 demonstrates a ±0.2% uncertainty, supported through the described methods.

The words “temporal trend” or “temporal trending” mean having time dependency. These words imply the use of historical records, that is records involving computed parameters based on this disclosure, records used to judge whether a given component or process is degrading, at steady state or improving as observed in such temporal trends.

Although the present invention has been described in considerable detail with regard to certain Preferred Embodiments thereof, other embodiments within the scope and spirit of the present invention are possible without departing from the general industrial applicability of the invention.

### DETAILED DESCRIPTION OF THE DRAWINGS

FIG. 1A is a visual representation of Exergetic Engines used to describe the thermodynamics of a shell and tube heat exchanger. Nomenclature includes: TI & TU refer to tube inlet & outlet states and flow; SI, SU and DI are shell-side inlets, outlet and return inlet drains states and flows. FIG. 1A defines: T_{CDS-Corr} ≡T_{CDS}+ΔT_{Corr}; where T_{CDS} is the absolute saturation temperature as f(P_{Cond}). Note that the symbol SI represents multiple input streams to the condenser's shell; typically, they comprise LP turbine exhaust, turbine seal flows, auxiliary turbine exhaust, valve stem leakages, and the like. This disclosure weights all shell-side inlet and outlet streams (SI, DI and SU) when developing the Σ_{Shell} (mg)ₖ term for Eq.(11); i.e., descriptive of “k” streams, resulting in a ΔT_{Corr}. Item 905 is a representation of the physical condenser. It is divided, for analytical purposes, into its sell 910 and its tube bank 915. The heat rejection, Q_{REJ}, is considered positive from the shell and negative from the tube blank. It is processed through the theoretical Exergetic Engines 920 and 925 which convert the ±Q_{REJ} to reversibilities and irreversibilities per Eqs.(4) & (5). Items 930 & 940 are fictional components, receptors of reversibilities. Items 935 & 945 are fictional components, receptors of irreversibilities. Items 930 thru 945 as thermodynamic receptors have no physical meaning.

FIG. 1B is a visual representation of an Exergetic Engine used to describe the thermodynamics of the shell-side of a heat exchanger which loses an energy flow to its local environment. Nomenclature, for example, assumes a nuclear power plant's Reactor Vessel heat loss associated with its outer flow annulus: RVI is the coolant's inlet state and flow, and RCI is the outlet from the outer annulus and entrance to the nuclear core. FIG. 1B defines: T_{RVI-Corr}≡T_{RVI}+ΔT_{Corr}; where T_{RVI} is the absolute RV inlet temperature. Item 955 is a representation of the shell-side of the physical heat exchanger. If describing a RV, then heat loss to the environment is generated from convection and thermal radiation losses (a positive Q_{conv}), and from heating structural materials and the coolant given dissipation of nuclear radiation from beta (β), gamma (γ) and neutron scattering. β and associated Bremsstrahlung radiation is spent between the peripheral fuel assemblies and the inner shell of the outer flow annulus. γ and ¹n₀ heating of RV structures occurs between the peripheral fuel assemblies and the outer RV vessel. Such heating effecting the net RV loss is accessed as the difference between the incident thermal dissipation present at the core's boundary, Q_{RadI}, less that loss to the environment, Q_{RadU}. Note, as defined in '822, nuclear radiation responsible for Q_{RadU}, if significant, can only be described as a pure irreversible loss from the system (use of an Exergetic Engine has no meaning). However, the gain in fluid energy flow from nuclear radiation and losses via convection net a RV shell loss (Q_{RV-Loss}); a [Q_{Conv}−(Q_{RadI}−Q_{RadU})]. If Q_{RV-Loss}>0.0 it is processed through a theoretical Exergetic Engine 970 which converts the energy flow to reversibilities and irreversibilities per Eq.(4). If negative, I_{RV-Loss}=0.0, and the effects |Q_{RV-Loss}| must be added to Core Thermal Power. Items 980 & 985 are fictional components, receptors of reversibilities and irreversibilities without physical meaning.

FIG. 2 is a representation of thermodynamic laws appropriate for both a nuclear or fossil engine. Items 710 and 810 represent a generic power system. System 710 is analyzed using Second Law exergy analysis. This same system 810 is also analyzed using First Law conservation of energy flows. The 710 and 810 system is either a complete Nuclear Steam Supply System (NSSS), a fossil-fired power plant, or an isolated Turbine Cycle. Items 720 and 820 are the same, descriptive of shaft powers entering the system; for example, these are the pump shaft powers associated with a NSSS, or for a fossil-fired system would include boiler recirculation pump power, TC pumps and combustion air fan shaft powers. Evaluation of shaft powers 720 & 820, require extensive properties at the inlets & outlets and mass flows associated with the pumps, fans, etc. Note that Eqs.(2ND) and (1ST) assume, by example, that Feedwater pumps are driven by an Auxiliary Turbine; thus a ΣP_{FWP-k2} shaft power term does not cross the system boundary. Items 725 and 825 are the same, descriptive of the same useful power output, P_{GEN}. For the power plant, P_{GEN} is an energy flow delivered to a turbine-generator shaft resulting in electric power; or P_{GEN} could describe an energy flow used for space heating. Resolution of P_{GEN} is made by matrix solution as taught in '822, or by direct measurement of the electric generation, accounting for generator losses; or a measured useful \dot{m}Δh steam flow. If 710 is an isolated Turbine Cycle, its G_{IN} is \dot{m}Δg supplied at the boundary; for 810 an energy flow, \dot{m}Δh, supplied; system output being P_{GEN}. Input quantities required to evaluate nuclear power 715, are supplied by the Neutronics Model and identified instrumentation needed to produce intensive properties discussed in '822. The Preferred Embodiment of analyzing a fossil-fired involves use of the computer simulator EX-FOSS. When monitoring in real time, On-Line Operating Parameters are required comprising extensive properties. The driving force behind nuclear fission produced power is neutron flux, Φ_{TH}, which is a declared unknown for the Preferred Embodiment and Alternative Embodiments A thru E discussed in '822. The driving force behind fossil-fired produced power is fuel mass flow, which is a computed output from the EX-FOSS program. ΣIₖ Item 730 is described generically by Eq.(53) in '822, applicable for nuclear or fossil. Individual Iₖ terms are taught through Eqs.(1) thru (18), and of course, require component indicated Ag and As extensive properties and mass flows. Critical for thermodynamically understanding a power plant is to establish nexus between Items 715 & 815 via their respective losses. If Item 710 is a nuclear power plant, its supplied nuclear potential (its Free Exergy) 715 is a f[Φ_{TH} Σ̅_{F}(υ̅_{REC}+υ̅_{TNU})], this same system 810 is supplied a thermal power 815 formed by converting the recoverable portion of 715, f[Φ_{TH} Σ̅_{F}υ̅_{REC}], using an Inertial Conversion Factor described by Eqs.(9) & (10) in '822. If Item 710 is a fossil-fired power plant, its supplied fossil potential 715 comprises principally the fuel and combustion air exergy flows. Its thermal power is the fuel's As-Fired mass flow times a corrected heating value, m_{AF}(HHVP+HBC), see patents '429 and '526.

FIG. 2 suggests a simultaneous evaluation of the potential and thermal powers' differing losses. Second Law description of a power system 710, states that the G_{IN} input consists of the total potential power supplied 715 plus any shaft power additions 720. G_{IN} is the total exergy flow supplied to the system (a potential); it is the system's maximum “available power”. G_{IN} is destroyed as the system creates P_{GEN} 725 and irreversible losses ΣIₖ 730. First Law description of this same power system 810 states that the total energy flow input consists of thermal plus shaft powers supplied; herein defined as Σ\dot{m}Δh_{IN} [Items 815 plus 820]. Σ\dot{m}Δh_{IN} is converted to P_{GEN} 825 and energy flows losses, principally heating the environment given the condenser's heat rejection 830 (Q_{REJ}) plus miscellaneous losses 835 (Q_{Loss-hh}); said losses are herein defined as ΣQ_{Loss}. The difference between Second and First Law treatments of exergy and energy flows supplied, and their associated losses, implies Second Law G_{IN} supplied less ΣIₖ, must equal First Law Σ\dot{m}Δh_{IN} supplied less ΣQ_{Loss}. Teachings such differences result in Eqs.(19) and (22), with associated discussions.

What is claimed is:

1. A computing apparatus which reduces uncertainty in a power plant's entropy flows, thereby improving its operation and safety, the computing apparatus comprising:
a data acquisition device to collect data associated with the power plant comprising Operating Parameters which include a set of Off-Line Operating Parameters, a set of On-Line Operating Parameters, the data acquisition device resulting in a set of acquired system input data;
analyze a set of paired performance metrics based the power plant's entropy flows and their temporal trends, said entropy flows based on differences between a Second Law exergy analysis of working fluid exergy flows and one First Law conservation selected from the group comprising:
a First Law conservation of working fluid energy flows which includes use of an Inertial Conversion Factor (Ξ) applicable for conversion of nuclear power to Core Thermal Power, and
a First Law conservation of working fluid energy flows which does not include the Inertial Conversion Factor;
a computer with a processing and memory means which includes an ability for processing a set of computer instructions and having memory for storage of temporal trends in the processed output data;
the set of computer instructions which comprise, when executed by the computer, the processing of the set of acquired system input data, processing analysis of the set of paired performance metrics and supporting technology, and processing output data, resulting in a programmed computer;
execution of the programmed computer based on the set of computer instructions;
examine the programmed computer's output data for a set of identified degradations within the power plant based on analysis of the set of paired performance metrics, for temporal trends in the output data, and for actions to be taken based on correcting the set of identified degradations;
action instigated by the power plant operator based on improved accuracy of the power plant's entropy flows by correcting the set of identified degradations, thereby improving the power plant's operation and safety.

2. The computing apparatus of claim 1, wherein analysis of the set of paired performance metrics includes use of a computed Inertial Conversion Factor based on neutronics data associated with a ²³⁵U fueled nuclear power plant (Ξ_{U235}), and a computed \dot{S}_{Nucl} Ratio which is based on Reactor Vessel coolant properties; and wherein
the set of computer instructions for processing output data which includes a difference between [Ξ_{U235}−1.0] and the \dot{S}_{Nucl} Ratio.

3. The computing apparatus of claim 1, wherein analysis of the set of paired performance metrics includes use of a computed Inertial Conversion Factor based on neutronics data associated with a Thorium fueled nuclear power plant breeding ²³³U (Ξ_{U233}), and a computed \dot{S}_{Nucl} Ratio which is based on Reactor Vessel coolant properties; and wherein
the set of computer instructions for processing output data which includes a difference between [Ξ_{U233}−1.0] and the \dot{S}_{Nucl} Ratio.

4. The computing apparatus of claim 1, wherein analysis of the set of paired performance metrics includes use of a computed Inertial Conversion Factor based on neutronics data associated with a nuclear power plant breeding ²³⁸U resulting in an average Ξ̅_{Breeder}(t) reflecting ²³⁵U, ²³⁹Pu and ²⁴¹Pu as a function of burnup, and a computed \dot{S}_{Nucl} Ratio which is based on Reactor Vessel coolant properties; and wherein
the set of computer instructions for processing output data which includes a difference between [Ξ̅_{Breeder}(t)−1.0] and the \dot{S}_{Nucl} Ratio.

5. The computing apparatus of claim 1, wherein the Second Law exergy analysis includes use of a Fixed T_{Ref}.

6. The computing apparatus of claim 1, wherein the Second Law exergy analysis includes use of a Floated T_{Ref}.

7. A computing apparatus which reduces uncertainty in irreversible loss in a power plant's condenser, thereby improving the power plant's operation and safety, the computing apparatus comprising:
a data acquisition device to collect data associated with the power plant comprising Operating Parameters which include a set of Off-Line Operating Parameters, a set of On-Line Operating Parameters, the data acquisition device resulting in a set of acquired system input data;
analyze the power plant's condenser by correcting its indicated saturation temperature based on the summation of exergy flows associated with the power plant's condenser shell-side, resulting in an Exergetic Engine whose analytics produce a highly accurate irreversible loss;
a computer with a processing and memory means which includes an ability for processing a set of computer instructions and having memory for storage of temporal trends in processed results;
the set of computer instructions which comprise, when executed by the computer, the processing of the set of acquired system input data, processing the Exergetic Engine's analytics for the power plant's condenser and for supporting technology, and processing output data, resulting in a programmed computer;
execution of the programmed computer based on the set of computer instructions;
examine the programmed computer's output data for a set of identified degradations within the power plant based on an improved accuracy of the power plant's condenser irreversible losses, for temporal trends in the output data, and for actions to be taken based on correcting the set of identified degradations;
action instigated by the power plant operator based on improved accuracy of the power plant's condenser irreversible loss by correcting the set of identified degradations, thereby improving the power plant's operation and safety.

8. The computing apparatus of claim 7, wherein processing the Exergetic Engine for its irreversible loss includes use of a Fixed T_{Ref}.

9. The computing apparatus of claim 7, wherein processing the Exergetic Engine for its irreversible loss includes use of a Floated T_{Ref}.

10. The computing apparatus of claim 7, wherein the heat exchanger's analytical model includes a heat exchanger's analytical model whose thermodynamic boundary is limited only to its shell-side.

11. The computing apparatus of claim 7, wherein the heat exchanger's analytical model includes a heat exchanger's analytical model whose thermodynamic boundary is limited only to its tube-side.

12. A computing apparatus which reduces uncertainty in Carnot Reversibility in a power plant's heat exchanger, thereby improving the power plant's operation and safety, the computing apparatus comprising:
a data acquisition device to collect data associated with the power plant comprising Operating Parameters which include a set of Off-Line Operating Parameters, a set of On-Line Operating Parameters, the data acquisition device resulting in a set of acquired system input data;
analyze the power plant's heat exchanger by correcting its T_{Hot} based on the summation of exergy flows associated with the power plant's heat exchanger T_{Hot} side, resulting in an Exergetic Engine whose analytics produce a highly accurate Carnot Reversibility;
a computer with a processing and memory means which includes an ability for processing a set of computer instructions and having memory for storage of temporal trends in processed results;
the set of computer instructions which comprise, when executed by the computer, the processing of the set of acquired system input data, processing the Exergetic Engine's analytics for the power plant's heat exchanger and for supporting technology, and processing output data, resulting in a programmed computer;
execution of the programmed computer based on the set of computer instructions;
examine the programmed computer's output data for a set of identified degradations within the power plant based on an improved accuracy of the power plant's heat exchanger Carnot Reversibilities, for temporal trends in the output data, and for actions to be taken based on correcting the set of identified degradations;
action instigated by the power plant operator based on improved accuracy of the power plant's heat exchanger Carnot Reversibilities by correcting the set of identified degradations, thereby improving the power plant's operation and safety.

13. The computing apparatus of claim 12, wherein processing the Exergetic Engine for its Carnot Reversibility includes use of a Fixed T_{Ref}.

14. The computing apparatus of claim 12, wherein processing the Exergetic Engine for its Carnot Reversibility includes use of a Floated T_{Ref}.

15. The computing apparatus of claim 12, wherein analysis of the power plant's heat exchanger includes correcting T_{Hot} for appropriate pressure drop effects using the Δg_{ΔP-Corr} quantity.

16. The computing apparatus of claim 12, wherein analysis of the power plant's heat exchanger includes use of a condenser analytical model associated with a Regenerative Rankin Cycle whose thermodynamic boundary only encloses the condenser's shell-side.
